(19) United States
(12) Patent Application Publication
(10) Pub. No.: US 2024/0393781 A1
(43) Pub. Date: Nov. 28, 2024

(54) METHOD FOR PREDICTING, MONITORING AND INCREASING RELIABILITY SUITABLE FOR IN-SERVICE NUCLEAR POWER PLANT

(71) Applicant: Shanghai Power Equipment Research Institute Co., Ltd, Shanghai (CN)

(72) Inventors: Jinyuan Shi, Shanghai (CN); Xuefei Fan, Shanghai (CN); Yuesheng Xie, Shanghai (CN); Luyi Jiang, Shanghai (CN); Jiamin Xu, Shanghai (CN); Siyuan Wang, Shanghai (CN); Lin Zhang, Shanghai (CN); Wangren Xu, Shanghai (CN); Yuxuan Wang, Shanghai (CN); Dexuan Wang, Shanghai (CN)

(73) Assignee: Shanghai Power Equipment Research Institute Co., Ltd, Shanghai (CN)

(21) Appl. No.: 18/348,036

(22) Filed: Jul. 6, 2023

(30) Foreign Application Priority Data
May 23, 2023 (CN) 202310587756X
May 23, 2023 (CN) 2023105854341
May 23, 2023 (CN) 2023105877413
May 23, 2023 (CN) 2023105880967

(51) Int. Cl. G05B 23/02; G21C 17/00

(52) U.S. Cl. CPC G05B 23/0283; G21C 17/00

(57) ABSTRACT

The present disclosure provides a method for predicting, monitoring and increasing reliability for an in-service nuclear power plant. The method includes obtaining a number of years of operation of the in-service nuclear power plant, determining a target reliability prediction category of the in-service nuclear power plant based on the number of years of operation; performing reliability prediction on the in-service nuclear power plant based on first reliability basic data of the in-service nuclear power plant if the target reliability prediction category is a first reliability prediction category; performing reliability prediction on the in-service nuclear power plant based on second reliability basic data of the in-service nuclear power plant if the target reliability prediction category is a second reliability prediction category; and performing reliability monitoring on the in-service nuclear power plant based on a reliability prediction value and a planned maintenance category of the in-service nuclear power plant.

### CROSS-REFERENCE TO RELATED APPLICATION

This application claims priority to and benefits of Chinese Patent Application No. 202310588096.7, No. 202310587741.3, No. 202310585434.1 and No. 202310587756.X, filed with the China National Intellectual Property Administration on May 23, 2023, the entire content of which is incorporated herein by reference.

### FIELD

The present disclosure relates to a technical field of an in-service nuclear power plant, and more particularly to a method for predicting and monitoring reliability suitable for an in-service nuclear power plant, a method for increasing reliability suitable for an in-service nuclear power plant, an apparatus for predicting and monitoring reliability suitable for an in-service nuclear power plant, an apparatus for increasing reliability suitable for an in-service nuclear power plant, an electronic device, a storage medium and a platform for monitoring reliability.

### BACKGROUND

At present, with energy shortage, it is urgently required to develop new energy to meet their energy needs. Nuclear power has been widely used due to energy conservation, environmental protection, and emission reduction. In-service nuclear power plant is an important device in nuclear power technology. In a related art, it is needed to predict reliability of the in-service nuclear power plant to ensure the normal operation. However, there are problems with low prediction accuracy and low monitoring accuracy in reliability monitoring of the in-service nuclear power plant, and there is a lack of a method for increasing reliability of the in-service nuclear power plant.

### SUMMARY

The present disclosure aims to solve at least one of the technical problems in the related art at least to some extent.

In view of this, in a first aspect of the present disclosure, a method for predicting and monitoring reliability is provided. The method is suitable for an in-service nuclear power plant and includes obtaining a number of years of operation of the in-service nuclear power plant, and determining a target reliability prediction category of the in-service nuclear power plant based on the number of years of operation; performing reliability prediction on the in-service nuclear power plant based on first reliability basic data of the in-service nuclear power plant in case that the target reliability prediction category is a first reliability prediction category; performing reliability prediction on the in-service nuclear power plant based on second reliability basic data of the in-service nuclear power plant in case that the target reliability prediction category is a second reliability prediction category; and performing reliability monitoring on the in-service nuclear power plant based on a reliability prediction value and a planned maintenance category of the in-service nuclear power plant.

In a second aspect of the present disclosure, a method for increasing reliability is provided. The method is suitable for an in-service nuclear power plant and includes performing reliability prediction on the in-service nuclear power plant based on a number of years of operation of the in-service nuclear power plant to obtain a reliability prediction value of the in-service nuclear power plant; determining abnormal reliability data of the in-service nuclear power plant based on a planned maintenance category of the in-service nuclear power plant in case that the reliability prediction value does not meet a monitoring qualification condition; optimizing the abnormal reliability data, and returning to perform a process of obtaining the reliability prediction value until the reliability prediction value obtained meets the monitoring qualification condition.

In a third aspect of the present disclosure, an apparatus for predicting and monitoring reliability is provided. The apparatus is suitable for an in-service nuclear power plant and includes a determining component configured to obtain a number of years of operation of the in-service nuclear power plant, and determine a target reliability prediction category of the in-service nuclear power plant based on the number of years of operation; a predicting component configured to perform reliability prediction on the in-service nuclear power plant based on first reliability basic data of the in-service nuclear power plant in case that the target reliability prediction category is a first reliability prediction category, or perform reliability prediction on the in-service nuclear power plant based on second reliability basic data of the in-service nuclear power plant in case that the target reliability prediction category is a second reliability prediction category; and a monitoring component configured to perform reliability monitoring on the in-service nuclear power plant based on a predicted reliability value and a planned maintenance category of the in-service nuclear power plant.

It is understood that the general description above and the detailed description in the following text are only illustrative and explanatory, and do not limit the present disclosure.

### BRIEF DESCRIPTION OF THE DRAWINGS

These and/or other aspects and advantages of embodiments of the present disclosure will become apparent and more readily appreciated from the following descriptions made with reference to the drawings, in which:

FIG. 1 is a flowchart showing a method for predicting and monitoring reliability suitable for an in-service nuclear power plant according to an embodiment of the present disclosure;

FIG. 2 is a flowchart showing a method for predicting and monitoring reliability suitable for an in-service nuclear power plant according to an embodiment of the present disclosure;

FIG. 3 is a flowchart showing a method for predicting and monitoring reliability suitable for an in-service nuclear power plant according to an embodiment of the present disclosure;

FIG. 4 is a flowchart showing a method for predicting and monitoring reliability suitable for an in-service nuclear power plant according to an embodiment of the present disclosure;

FIG. 5 is a flowchart showing a method for predicting and monitoring reliability suitable for an in-service nuclear power plant according to an embodiment of the present disclosure;

FIG. 6 is a flowchart showing a method for predicting and monitoring reliability suitable for an in-service nuclear power plant according to an embodiment of the present disclosure;

FIG. 7 is a flowchart showing a method for increasing reliability suitable for an in-service nuclear power plant according to an embodiment of the present disclosure;

FIG. 8 is a flowchart showing a method for increasing reliability suitable for an in-service nuclear power plant according to an embodiment of the present disclosure;

FIG. 9 is a schematic diagram showing an apparatus for predicting and monitoring reliability suitable for an in-service nuclear power plant according to an embodiment of the present disclosure;

FIG. 10 is a schematic diagram showing an apparatus for increasing reliability suitable for an in-service nuclear power plant according to an embodiment of the present disclosure;

FIG. 11 is a schematic diagram showing an electronic device according to an embodiment of the present disclosure.

### DETAILED DESCRIPTION

Embodiments of the present disclosure are described in detail below, examples of which are illustrated in the drawings. The same or similar elements are denoted by same reference numerals in different drawings unless indicated otherwise. The embodiments described herein with reference to drawings are explanatory, and configured to generally understand the present disclosure. The embodiments shall not be construed to limit the present disclosure.

The following describes a method for predicting and monitoring reliability suitable for an in-service nuclear power plant, a method for increasing reliability suitable for an in-service nuclear power plant, an apparatus for predicting and monitoring reliability suitable for an in-service nuclear power plant, an apparatus for increasing reliability suitable for an in-service nuclear power plant, an electronic device, a storage medium and a platform for monitoring reliability.

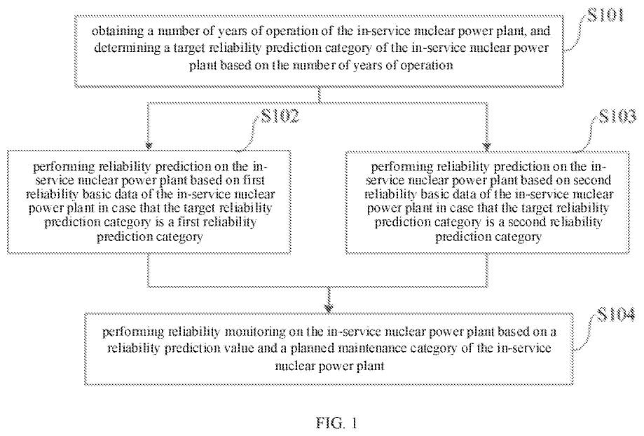

FIG. 1 is a flowchart showing a method for predicting and monitoring reliability suitable for an in-service nuclear power plant according to an embodiment of the present disclosure.

As shown in FIG. 1, the method for predicting and monitoring reliability suitable for the in-service nuclear power plant in embodiments of the present disclosure includes the following steps S101 to S104.

In step S101, a number of years of operation of the in-service nuclear power plant is obtained, and a target reliability prediction category of the in-service nuclear power plant is determined based on the number of years of operation.

In some embodiments of the present disclosure, reliability prediction is performed in a current year of operation of the in-service nuclear power plant in a previous year or in January of each year.

It is noted that the method for predicting and monitoring reliability suitable for the in-service nuclear power plant has a high precision, which may be executed by the apparatus for predicting and monitoring reliability suitable for the in-service nuclear power plant in embodiments of the present disclosure. The apparatus for predicting and monitoring reliability suitable for the in-service nuclear power plant may be configured in any platform for predicting and monitoring reliability suitable for an in-service nuclear power plant, to perform the method for predicting and monitoring reliability suitable for the in-service nuclear power plant in embodiments of the present disclosure.

It is noted that the number of years of operation refers to a cumulative number of years of operation of the in-service nuclear power plant.

In some embodiments, determining the target reliability prediction category of the in-service nuclear power plant based on the number of years of operation includes: determining the target reliability prediction category as the first reliability prediction category in case that the number of years of operation is less than a first set threshold; or determining that the target reliability prediction category as the second reliability prediction category in case that the number of years of operation is greater than or equal to the first set threshold. In this way, in the method, the target reliability prediction category is determined based on a relationship between the number of years of operation and the first set threshold.

It is noted that the first set threshold may be selected as needs in actual, such as 5 years.

In some embodiments, determining the target reliability prediction category for the in-service nuclear power plant based on the number of years of operation includes identifying a set interval in which the number of years of operation is located. The target reliability prediction category is obtained based on the corresponding relationship between the set interval for the number of years of operation and the target reliability prediction category.

It is understood that the number of years of operation may be divided into a plurality of set intervals, and the corresponding relationship between each set interval and the reliability prediction category may be established. Different set intervals may correspond to different reliability prediction categories.

In some embodiments, the number of years of operation of the in-service nuclear power plant may be obtained in one year before the current year of operation or in January of the current year of operation, so as to predict reliability of the in-service nuclear power plant with a high-precision.

In step S102, in case that the target reliability prediction category is a first reliability prediction category, reliability prediction is performed on the in-service nuclear power plant based on first reliability basic data of the in-service nuclear power plant.

In step S103, in case that the target reliability prediction category is a second reliability prediction category, reliability prediction is performed on the in-service nuclear power plant based on second reliability basic data of the in-service nuclear power plant.

In some embodiments of the present disclosure, the target reliability prediction category may be the first reliability prediction category or the second reliability prediction category, and the first reliability basic data is different from the second reliability basic data. In some embodiment, the first reliability basic data and the second reliability basic data may include reliability characteristic quantities and planned outage factors. The reliability characteristic quantity may include an equivalent availability factor.

In some embodiments, performing reliability prediction on the in-service nuclear power plant includes in the previous year or in January of each year, predicting reliability characteristics in the current year of operation of the in-service nuclear power plant.

In some embodiments, performing reliability prediction on the in-service nuclear power plant based on the first reliability basic data of the in-service nuclear power plant includes performing reliability prediction on the in-service nuclear power plant based on a reliability prediction strategy corresponding the first reliability prediction category and the first reliability basic data.

In some embodiments, performing reliability prediction on the in-service nuclear power plant based on the second reliability basic data of the in-service nuclear power plant includes performing reliability prediction on the in-service nuclear power plant based on a reliability prediction strategy corresponding the second reliability prediction category and the second reliability basic data.

In some embodiments, a corresponding relationship between each reliability prediction category and reliability basic data and a corresponding relationship between each reliability prediction category and reliability prediction strategy may be established. Based on the reliability prediction category, the reliability basic data and reliability prediction strategy of the in-service nuclear power plant may be determined, which includes obtaining the reliability basic data and reliability prediction strategy based on the corresponding relationship between the reliability prediction category, reliability basic data and reliability prediction strategy.

In some embodiments, performing reliability prediction on the in-service nuclear power plant based on the first reliability basic data of the in-service nuclear power plant includes inputting the first reliability basic data into a reliability prediction model, and outputting a reliability prediction value of the in-service nuclear power plant by the reliability prediction model. It is noted that the reliability prediction model may be selected as needs in actual, such as deep learning models. The reliability prediction model may be obtained by pretraining.

In step S104, reliability monitoring is performed on the in-service nuclear power plant based on a reliability prediction value and a planned maintenance category of the in-service nuclear power plant.

It is noted that the reliability prediction value may be obtained by predicting the reliability of the in-service nuclear power plant. The reliability prediction value refers to a prediction value of the reliability characteristic quantity of the in-service nuclear power plant in the current year of operation.

It is noted that the planned maintenance category for the in-service nuclear power plant may be set by users.

In some embodiments, the planned maintenance categories of the in-service nuclear power plants include the following four categories.

A first type of the planned maintenance category is conventional island planned overhaul. An interval of the conventional island planned overhaul for the in-service nuclear power plant is 6 to 12 years, and a duration of the planned overhaul for the in-service nuclear power plant is 60 to 80 days.

A second type of the planned maintenance category is nuclear island refueling overhaul. An interval of the nuclear island refueling overhaul for the in-service nuclear power plant is 12 to 18 months, and a duration of the nuclear island refueling overhaul for the in-service nuclear power plant is 20 to 40 days.

A third type of the planned maintenance category is holiday scheduled maintenance, which is scheduled once in a year of unplanned island overhaul and island refueling overhaul of in-service nuclear power plants. A planned duration of the holiday maintenance days for the in-service nuclear power plant is 5 to 15 days.

A fourth type of the planned maintenance category is unplanned maintenance category, which means there is no conventional island planned overhaul, nuclear island refueling overhaul, or holiday scheduled maintenance in the year.

In some embodiments, performing reliability monitoring on the in-service nuclear power plant based on the reliability prediction values and the planned maintenance categories includes obtaining reliability monitoring criteria for the in-service nuclear power plant based on the planned maintenance categories; determining that there is no reliability anomaly in the in-service nuclear power plant in case that the reliability prediction value is greater than or equal to a reliability monitoring criteria value; determining that there is a reliability anomaly in the in-service nuclear power plant in case that the reliability prediction value is less than the reliability monitoring criteria value.

In some embodiments, after determining that there is no reliability anomaly in the in-service nuclear power plant, the method further includes generating indicator information to indicate that there is no reliability anomaly in the in-service nuclear power plant, and timely informing users that there is no reliability anomaly in the in-service nuclear power plant.

In some embodiments, after determining that reliability anomalies occur in the in-service nuclear power plant, the method further includes generating indicator information to indicate that reliability anomalies occur in the in-service nuclear power plant, and timely informing users that reliability anomalies occur in the in-service nuclear power plant.

In some embodiments, a mapping relationship between the planned maintenance category and the reliability monitoring criterion value may be established in advance. Obtaining the reliability monitoring criterion value of the in-service nuclear power plant based on the planned maintenance category may include querying the reliability monitoring criterion value in the above-mentioned mapping relationship based on the category of the in-service nuclear power plant and the planned maintenance category, and determining the reliability monitoring criterion value queried as the reliability monitoring criterion value of the in-service nuclear power plant.

In summary, the number of years of operation of the in-service nuclear power plant is obtained, and a target reliability prediction category of the in-service nuclear power plant is determined based on the number of years of operation. In case that the target reliability prediction category is a first reliability prediction category, reliability prediction is performed on the in-service nuclear power plant based on first reliability basic data of the in-service nuclear power plant. In case that the target reliability prediction category is a second reliability prediction category, reliability prediction is performed on the in-service nuclear power plant based on second reliability basic data of the in-service nuclear power plant. Reliability monitoring is performed on the in-service nuclear power plant based on a reliability prediction value and a planned maintenance category of the in-service nuclear power plant. In this way, the target reliability prediction category may be determined based on the number of years of operation of in-service nuclear power plants, so as to predict the reliability of the in-service nuclear power plant, thereby improving the prediction accuracy of reliability of the in-service nuclear power plant. The reliability prediction value and the planned maintenance category of the in-service nuclear power plant are comprehensively considered to monitor the reliability of the in-service nuclear power plant, thereby improving the monitoring accuracy of reliability of the in-service nuclear power plant. The planned and unplanned maintenance days of the in-service nuclear power plant may also be optimized and improved, so as to increase reliability of the in-service nuclear power plant.

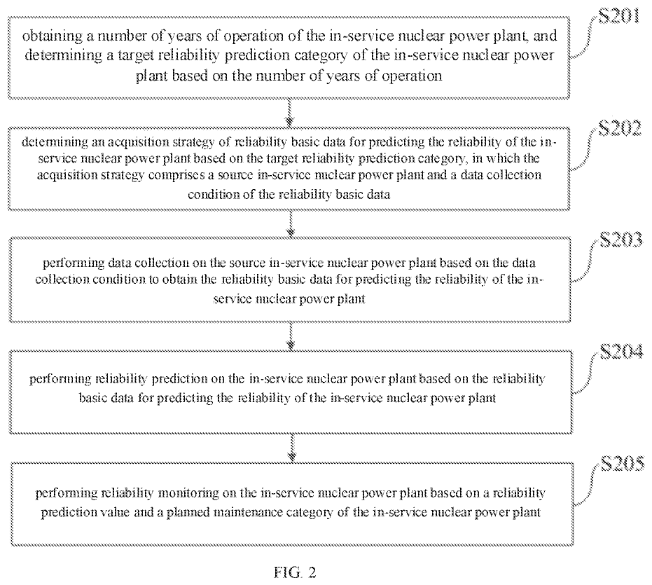

FIG. 2 is a flowchart showing a method for predicting and monitoring reliability suitable for an in-service nuclear power plant according to an embodiment of the present disclosure.

As shown in FIG. 2, the method for predicting and monitoring reliability suitable for the in-service nuclear power plant in embodiments of the present disclosure includes the following steps S201 to S205.

In step S201, a number of years of operation of the in-service nuclear power plant is obtained, and a target reliability prediction category of the in-service nuclear power plant is determined based on the number of years of operation.

The relevant content of step S201 may be found in the above-mentioned embodiments, which will not be repeated here.

In step S202, an acquisition strategy of reliability basic data for predicting the reliability of the in-service nuclear power plant is determined based on the target reliability prediction category. The acquisition strategy includes a source in-service nuclear power plant and a data collection condition of the reliability basic data.

In step S203, data collection is performed on the source in-service nuclear power plant based on the data collection condition to obtain the reliability basic data for predicting the reliability of the in-service nuclear power plant.

It is noted that the data collection condition may include data category, data quantity, historical year of operation that the data belongs, which may be selected as needs in actual.

In some embodiments, a mapping relationship between the target reliability prediction category and the acquisition strategy may be established in advance. Determining the acquisition strategy for the reliability basic data for predicting the in-service nuclear power plant based on the target reliability prediction category includes querying the acquisition strategy in the above-mentioned mapping relationship based on the target reliability prediction category, and determining the acquisition strategy queried as the acquisition strategy for the reliability basic data for predicting the in-service nuclear power plant.

In some embodiments, in case that the target reliability prediction category is the first reliability prediction category, a reference in-service nuclear power plant with the same power as the in-service nuclear power plant is determined as the source in-service nuclear power plant. The reliability basic data of the in-service nuclear power plant under in plurality of historical years of operation is obtained as the first reliability basic data of the in-service nuclear power plant.

It is noted that the historical year of operation refers to the year of operation before the current year of operation, and there is no excessive limit on the number of historical years of operation under the first reliability prediction category. For example, the historical year of operation may include N years before the current year of operation, where N is a first set threshold. For example, the first set threshold is N=5, if the target reliability prediction category is the first reliability prediction category and the current year of operation of the in-service nuclear power plant is 2023, the historical years of operation may include 2018 to 2022.

In some embodiments, in case that the target reliability prediction category is the second reliability prediction category, the in-service nuclear power plant is determined as the source in-service nuclear power plant, and the reliability basic data of the in-service nuclear power plant in the plurality of historical years of operation is obtained as the second reliability basic data of the in-service nuclear power plant.

It is noted that the number of historical years of operation in the second reliability prediction category, for example, may include the previous T years of the current year of operation, where T is greater than or equal to N. For example, the first set threshold is N=5, if the target reliability prediction category is the second reliability prediction category and the current year of operation of the in-service nuclear power plant is 2023, the historical years of operation may include 2013 to 2022.

In step S204, reliability prediction is performed on the in-service nuclear power plant based on reliability basic data of the in-service nuclear power plant.

It is noted that if the target reliability prediction category is the first reliability prediction category, the reliability basic data for predicting the in-service nuclear power plant is the first reliability basic data. Based on the reliability basic data for predicting the in-service nuclear power plant, performing reliability prediction on the in-service nuclear power plant includes performing reliability prediction based on the first reliability basic data.

It is noted that if the target reliability prediction category is the second reliability prediction category, the reliability basic data for predicting the in-service nuclear power plant is the second reliability basic data. Based on the reliability basic data for predicting the in-service nuclear power plant, performing reliability prediction on the in-service nuclear power plant includes performing reliability prediction based on the second reliability basic data.

In step S205, reliability monitoring is performed on the in-service nuclear power plant based on a reliability prediction value and a planned maintenance category of the in-service nuclear power plant.

The relevant content of step S205 may be found in the above-mentioned embodiments, which will not be repeated here.

In summary, according to the method for high-precision predicting and monitoring reliability suitable for the in-service nuclear power plant in embodiments of the present disclosure, the acquisition strategy of reliability basic data for predicting the reliability of the in-service nuclear power plant is determined based on the target reliability prediction category. The acquisition strategy includes a source in-service nuclear power plant and a data collection condition of the reliability basic data. Data collection is performed on the source in-service nuclear power plant based on the data collection condition to obtain the reliability basic data for predicting the reliability of the in-service nuclear power plant. Reliability prediction is performed on the in-service nuclear power plant based on reliability basic data of the in-service nuclear power plant. In this way, the target reliability prediction category may be considered to determine the acquisition strategy, so as to obtain the basic reliability data for predicting the in-service nuclear power plant, and perform reliability prediction on the in-service nuclear power plant.

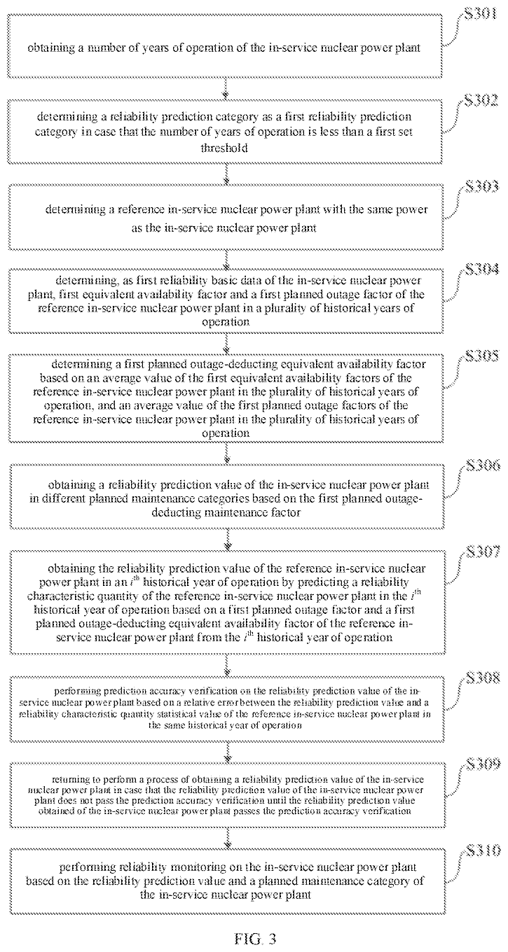

FIG. 3 is a flowchart showing a method for predicting and monitoring reliability suitable for an in-service nuclear power plant according to an embodiment of the present disclosure.

As shown in FIG. 3, the method for predicting and monitoring reliability suitable for the in-service nuclear power plant includes the following steps S301 to S310.

In step S301, a number of years of operation of the in-service nuclear power plant is obtained.

In step S302, a target reliability prediction category is determined as a first reliability prediction category in case that the number of years of operation is less than a first set threshold.

In step S303, a reference in-service nuclear power plant with the same power as the in-service nuclear power plant is determined.

In some embodiments, the source in-service nuclear power plant is the reference in-service nuclear power plant with the same power as the in-service nuclear power plant. For example, if a power of an in-service nuclear power plant 1 is 1000 MW and the years of operation is larger than 4 years but less than 5 years, in case that the first threshold is set as 5 years, it may be determined that the number of years of operation is less than 5 years, the target reliability prediction category is determined as the first reliability prediction category, and an in-service nuclear power plant 2 with a power of 1000 MW is determined as the reference in-service nuclear power plant.

In step S304, a first equivalent availability factor and a first planned outage factor of the reference in-service nuclear power plant in the plurality of historical years of operation is determined as first reliability basic data of the in-service nuclear power plant.

For example, a first equivalent availability factor (E_{AF}) and a first planned outage factor (P_{OF}) of the in-service nuclear power plant 2 in the past 5 years may be obtained as the first reliability basic data of in-service nuclear power plant 1. The first equivalent availability factor and the first planned outage factor of the in-service nuclear power plant 2 in the past 5 years are shown in Table 1.

TABLE 1
Statistical values of the first equivalent availability
factor and the first planned outage factor of the in-
service nuclear power plant 2 in the past 5 years

| number | first equivalent availability factor | | first planned outage factor | |
|---|---|---|---|---|
| j | symbol | value | symbol | value |
| 1 | E_{AF}(tᵢ₋₁) | 0.8948 | P_{OF}(tᵢ₋₁) | 0.0562 |
| 2 | E_{AF}(tᵢ₋₂) | 0.9005 | P_{OF}(tᵢ₋₂) | 0.0654 |
| 3 | E_{AF}(tᵢ₋₃) | 0.9001 | P_{OF}(tᵢ₋₃) | 0.0682 |
| 4 | E_{AF}(tᵢ₋₄) | 0.9158 | P_{OF}(tᵢ₋₄) | 0.0582 |
| 5 | E_{AF}(tᵢ₋₅) | 0.9000 | P_{OF}(tᵢ₋₅) | 0.0708 |

where tᵢ represents a current year of operation, E_{AF}(tᵢ₋ⱼ) represents a first equivalent availability factor of the in-service nuclear power plant 2 in the historical year tᵢ₋ⱼ of operation, and P_{OF}(tᵢ₋ⱼ) represents a first planned outage factor of the in-service nuclear power plant 2 in the historical year tᵢ₋ⱼ of operation, where with 1≤j≤5, and j is a positive integer.

In step S305, the first planned outage-deducting equivalent availability factor is determined based on an average value of the first equivalent availability factors of the source in-service nuclear power plant in the plurality of historical years of operation, and an average value of the first planned outage factors of the source in-service nuclear power plant in the plurality of historical years of operation.

The average value of the first equivalent availability factor E_{AFm} for the in-service nuclear power plate 2 in the past 5 years is as follows:

$${E}_{A F m} = \frac{{E}_{A F} ( {t}_{i - 1} ) + {E}_{A F} ( {t}_{i - 2} ) + {E}_{A F} ( {t}_{i - 3} ) + {E}_{A F} ( {t}_{i - 4} ) + {E}_{A F} ( {t}_{i - 5} )}{5} = \frac{0.8948 + 0.9005 + 0.9001 + 0.9158 + 0.9000}{5} = 0.90 226.$$

The average value of the planned outage factor P_{OFm} for the in-service nuclear power plant 2 in the past 5 years is calculated as follows:

$${P}_{O F m} = \frac{{P}_{O F} ( {t}_{i - 1} ) + {P}_{O F} ( {t}_{i - 2} ) + {P}_{O F} ( {t}_{i - 3} ) + {P}_{O F} ( {t}_{i - 4} ) + {P}_{O F} ( {t}_{i - 5} )}{5} = \frac{0.0562 + 0.0654 + 0.0682 + 0.0582 + 0.0708}{5} = 0.06 376.$$

The first planned outage-deducting equivalent availability factor E_{APm} for the in-service nuclear power plant 2 is calculated as follows:

$${E}_{A P m} = \frac{{E}_{A F m}}{1 - {P}_{OFm}} = \frac{0.90226}{1 - 0.06376} = 0.96 371.$$

In step S306, the reliability prediction value of the in-service nuclear power plant in different planned maintenance categories is obtained based on the first planned outage-deducting equivalent availability factor.

In some embodiments, obtaining the reliability prediction value of the in-service nuclear power plant in different planned maintenance categories based on the first planned outage-deducting equivalent availability factor includes inputting the first planned outage-deducting equivalent availability factor into a reliability prediction model, and outputting the reliability prediction values of the in-service nuclear power plant in different planned maintenance categories from the reliability prediction model.

In some embodiments, the method further includes obtaining planned maintenance data for the in-service nuclear power plant. The planned maintenance data includes planned maintenance categories, planned maintenance days, and newly added unplanned maintenance days Δu_{d}, etc.

In some embodiments, the planned maintenance categories of the in-service nuclear power plants include the following four categories.

A first type of the planned maintenance category is conventional island planned overhaul. An interval of the conventional island planned overhaul for the in-service nuclear power plant is 6 to 12 years, and a duration of the planned overhaul for the in-service nuclear power plant is 60 to 80 days.

A second type of the planned maintenance category is nuclear island refueling overhaul. An interval of the nuclear island refueling overhaul for the in-service nuclear power plant is 12 to 18 months, and a duration of the nuclear island refueling overhaul for the in-service nuclear power plant is 20 to 40 days.

A third type of the planned maintenance category is holiday scheduled maintenance, which is scheduled once in a year of unplanned island overhaul and island refueling overhaul of in-service nuclear power plants. A planned duration of the holiday maintenance days for the in-service nuclear power plant is 5 to 15 days.

A fourth type of the planned maintenance category is unplanned maintenance category, which means there is no conventional island planned overhaul, nuclear island refueling overhaul, or holiday scheduled maintenance for the year.

In some embodiments, the planned maintenance days include conventional island planned maintenance days m₁, nuclear island refueling maintenance days m₂, and holiday planned maintenance days m₃.

In some embodiments, obtaining the reliability prediction values of the nuclear power plants under different planned maintenance categories based on the first planned outage-deducting equivalent availability factor includes the following implementation process.

In a first process, if the planned maintenance category only includes conventional island planned overhaul, the reliability prediction value for the in-service nuclear power plants in the year of conventional island planned overhaul is obtained based on the first planned outage-deducting equivalent availability factor, conventional islands planned overhaul days and newly added unplanned maintenance days for the in-service nuclear power plant.

For example, if the planned maintenance category of the in-service nuclear power plant 1 in the current year of operation only includes conventional island planned overhaul, the conventional islands planned overhaul days for the in-service nuclear power plant 1 in the current year of operation is m₁=70 days, and the newly added unplanned maintenance days for the in-service nuclear power plant 1 in the current year of operation is Δu_{d}=7 days, the predicted equivalent availability factor E_{AF1}(tᵢ) of the in-service nuclear power plant 1 in the conventional island planned overhaul year is calculated as follows:

$$\begin{matrix}{E}_{AF 1} ( {t}_{i} ) = {E}_{APm} ( 1 - \frac{24 {m}_{1}}{8760} ) - \frac{24 Δ {u}_{d}}{8760} \\ = 0.96371 ( 1 - \frac{24 \times 70}{8760} ) - \frac{24 \times 7}{8760} \\ = 0.7597 .\end{matrix}$$

In a second process, if the planned maintenance category only includes nuclear island refueling overhaul, the reliability prediction value of the in-service nuclear power plants in the year of nuclear island refueling overhaul is obtained based on the first planned outage-deducting equivalent availability factor, the number of days of nuclear island refueling overhaul for the in-service nuclear power plants, and the newly added unplanned maintenance days.

For example, if the planned maintenance category of the in-service nuclear power plant 1 only includes nuclear island refueling overhaul in the current year of operation, and the number of days for nuclear island refueling overhaul in the in-service nuclear power plant 1 in the current year of operation is m₂=33 days, and the newly added unplanned maintenance days in the in-service nuclear power plant 1 in the current year of operation is Δu_{d}=7 days, the predicted equivalent availability factor E_{AF1}(tᵢ) of the in-service nuclear power plant 1 during the nuclear island refueling outage year is calculated as follows:

$$\begin{matrix}{E}_{AF 1} ( {t}_{i} ) = {E}_{APm} ( 1 - \frac{24 {m}_{2}}{8760} ) - \frac{24 Δ {u}_{d}}{8760} \\ = 0.96 371 ( 1 - \frac{24 \times 33}{8760} ) - \frac{24 \times 7}{8760} \\ = 0.8574 .\end{matrix}$$

In a third process, if the planned maintenance category only includes holiday planned maintenance, the reliability prediction value of the in-service nuclear power plants in holiday planned maintenance years is obtained based on the first planned outage-deducting equivalent availability factor, the holiday planned maintenance days of the in-service nuclear power plants, and the newly added unplanned maintenance days.

For example, if the planned maintenance category of the in-service nuclear power plant 1 in the current year of operation only includes holiday planned maintenance, and the planned holiday maintenance days of the in-service nuclear power plant 1 in the current year of operation is m₃=14 days, the newly added unplanned maintenance days of the in-service nuclear power plant 1 in the current year of operation is Δu_{d}=7 days, the predicted equivalent availability factor E_{AF1}(tᵢ) of the in-service nuclear power plant 1 under holiday planned maintenance is calculated as follows:

$$\begin{matrix}{E}_{AF 1} ( {t}_{i} ) = {E}_{APm} ( 1 - \frac{24 {m}_{3}}{8760} ) - \frac{24 Δ {u}_{d}}{8760} \\ = 0.96371 ( 1 - \frac{24 \times 14}{8760} ) - \frac{24 \times 7}{8760} \\ = 0.9076 .\end{matrix}$$

In a fourth process, if the planned maintenance category is unplanned maintenance category, the reliability prediction value of the in-service nuclear power plants in unplanned maintenance years is obtained based on the first planned outage-deducting equivalent availability factor and the newly added unplanned maintenance days of the in-service nuclear power plants.

For example, if the planned maintenance category of the in-service nuclear power plant 1 is unplanned maintenance category in the current year of operation, and the newly added unplanned maintenance days of the in-service nuclear power plant 1 in the current year of operation is Δu_{d}=10 days, the predicted equivalent availability factor E_{AF1}(tᵢ) of the in-service nuclear power plant 1 in the unplanned maintenance year is calculated as follows:

$${E}_{AF 1} ( {t}_{i} ) = {E}_{Apm} - \frac{24 Δ {u}_{d}}{8760} = 0.96371 - \frac{24 \times 10}{8760} = 0.9 363.$$

In step S307, the reliability prediction value of the reference in-service nuclear power plant in an i^{th} historical year of operation is obtained by predicting a reliability characteristic quantity of the reference in-service nuclear power plant in the i^{th} historical year of operation based on a first planned outage factor and a first planned outage-deducting equivalent availability factor of the reference in-service nuclear power plant from the i^{th} historical year of operation.

In step S308, prediction accuracy verification is performed on the reliability prediction value of the in-service nuclear power plant based on a relative error between the reliability prediction value and a reliability characteristic quantity statistical value of the source in-service nuclear power plant in the same historical year of operation.

In step S309, if the reliability prediction value of the in-service nuclear power plant does not pass the prediction accuracy verification, a process of obtaining the reliability prediction value of the in-service nuclear power plant is returned until the reliability prediction value obtained of the in-service nuclear power plant passes the prediction accuracy verification.

In this way, the method may verify the prediction accuracy of the reliability prediction values of the in-service nuclear power plants, and return to perform a process of obtaining the reliability prediction values of the in-service nuclear power plants when the reliability prediction values do not pass the prediction accuracy verification, until the obtained reliability prediction values of the in-service nuclear power plants pass the prediction accuracy verification. That is, the process of obtaining the reliability prediction values of the in-service nuclear power plants may be repeated, until the prediction accuracy of reliability prediction values for the in-service nuclear power plants is relatively high, which may achieve high-precision prediction of reliability prediction values for the in-service nuclear power plants.

For example, in the in-service nuclear power plant 1 and the in-service nuclear power plant 2, a relative error Eᵣ₁ between the prediction value of the equivalent availability factor E_{AF1}(tᵢ₋ⱼ) and a first statistical value of the equivalent availability factor E_{AF}(tᵢ₋ⱼ) of the in-service nuclear power plant 2 in the historical years tᵢ₋ⱼ of operation is calculated as follows:

$$\begin{matrix}{E}_{r 1} = \frac{{E}_{AF 1} ( {t}_{i} - j ) - {E}_{AF} ( {t}_{i} - j )}{{E}_{AF} ( {t}_{i} - j )} \\ = \frac{{E}_{APm} [ 1 - {P}_{OF} ( {t}_{i} - j ) ] - {E}_{AF} ( {t}_{i} - j )}{{E}_{AF} ( {t}_{i} - j )} \times 1 \; 00 \% .\end{matrix}$$

The calculation results of the relative error Eᵣ₁ between the prediction value of the equivalent availability factor E_{AF1}(tᵢ₋ⱼ) and the statistical value of the first equivalent availability factor E_{AF}(tᵢ₋ⱼ) of the in-service nuclear power plant 2 in the historical years tᵢ₋ⱼ of operation are shown in Table 2.

TABLE 2
Calculation results of relative error of the in-
service nuclear power plant 2 in the last 5 years

| number | E_{APm} | P_{OF}(tᵢ − j) | E_{AF1}(tᵢ − j) = E_{APm} × [1 − P_{OF}(tᵢ − j)] | E_{AF}(tᵢ − j) | Eᵣ₁/% |
|---|---|---|---|---|---|
| 1 | 0.96371 | 0.0562 | 0.9095 | 0.8948 | 1.64% |
| 2 | 0.96371 | 0.0654 | 0.9007 | 0.9005 | 0.02% |
| 3 | 0.96371 | 0.0682 | 0.8980 | 0.9001 | −0.23% |
| 4 | 0.96371 | 0.0582 | 0.9076 | 0.9158 | −0.90% |
| 5 | 0.96371 | 0.0708 | 0.8955 | 0.9000 | −0.50% |

In some embodiments, based on the relative error between the reliability prediction value and the reliability characteristic quantity statistical value of the reference in-service nuclear power plant in the same historical years of operation, the prediction accuracy of the reliability prediction value of the in-service nuclear power plant is verified, which includes if an absolute value of the relative error of the reference in-service nuclear power plant in a plurality of historical years of operations is less than or equal to the second set threshold, the reliability prediction value of the in-service nuclear power plant is determined by prediction accuracy verification, or if the absolute value of the relative error of the reference in-service nuclear power plant in at least one historical years of operation is greater than the second set threshold, it is determined that the target reliability prediction value of the in-service nuclear power plant does not pass prediction accuracy verification.

For example, in Table 2, if the second set threshold is 1.9%, the absolute values of the relative errors of the in-service nuclear power plant 2 in the past 5 years are all less than 1.70%, and it is determined that the prediction value of the equivalent availability factor of the in-service nuclear power plant group 1 has been verified through prediction accuracy verification.

In step S310, based on the reliability prediction values and the planned maintenance categories of the in-service nuclear power plants, reliability monitoring is performed on the in-service nuclear power plants.

The relevant content of step S310 may be found in the above-mentioned embodiments, which will not be repeated here.

In summary, according to the method for high-precision predicting and monitoring reliability suitable for the in-service nuclear power plant in embodiments of the present disclosure, the first planned outage-deducting equivalent availability factor is determined based on the average value of the first equivalent availability factors of the reference in-service nuclear power plant in the plurality of historical years of operation, and the average value of the first planned outage factors of the reference in-service nuclear power plant in the plurality of historical years of operation. The reliability prediction value of the in-service nuclear power plant in different planned maintenance categories is obtained based on the first planned outage-deducting equivalent availability factor, which is suitable for high-precision reliability prediction of the first reliability prediction category of the in-service nuclear power plants.

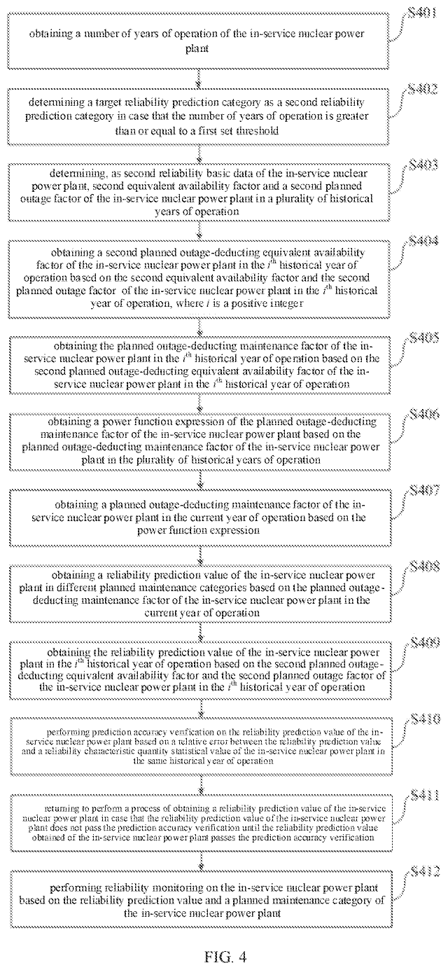

FIG. 4 is a flowchart showing a method for predicting and monitoring reliability suitable for an in-service nuclear power plant according to an embodiment of the present disclosure.

As shown in FIG. 4, the method for predicting and monitoring reliability suitable for an in-service nuclear power plant includes the following steps S401 to S412.

In step S401, a number of years of operation of the in-service nuclear power plant is obtained.

In step 402, a target reliability prediction category is determined as a second reliability prediction category in case that the number of years of operation is greater than or equal to a first set threshold.

In step S403, a second equivalent availability factor and a second planned shutdown factor of the in-service nuclear power plant in plurality of historical years of operation is determined as second reliability basic data of the in-service nuclear power plant.

For example, if a power of an in-service nuclear power plant 3 is 1100 MW and has been in operation for 6 years but less than 7 years, in case that the first threshold is set as 5 years, it may be determined that the number of years in operation has reached 6 years, and the target reliability prediction category is determined as the second reliability prediction category. The second equivalent availability factor E_{AF} and the second planned shutdown factor P_{OF} of the in-service nuclear power plant 3 in the past 6 years may be obtained and determined as the second reliability basic data of the in-service nuclear power plant 3. The second equivalent availability factor and the second planned shutdown factor of the in-service nuclear power plant 3 in the past 6 years are shown in Table 3.

TABLE 3
Statistical value of the in-service nuclear
power plant 3 in the last 6 years

| year of operation sᵢ | E_{AF}(sᵢ) | P_{OF}(sᵢ) | E_{AP}(sᵢ) | ρ(sᵢ) |
|---|---|---|---|---|
| 1 | 0.9171 | 0.0827 | 0.999782 | 0.000206 |
| 2 | 0.9022 | 0.0971 | 0.999225 | 0.000784 |
| 3 | 0.9969 | 0 | 0.996900 | 0.003110 |
| 4 | 0.9178 | 0.0820 | 0.999782 | 0.000218 |
| 5 | 0.9042 | 0.0958 | 1.000000 | 0.000001 |
| 6 | 1.0000 | 0 | 1.000000 | 0.000001 |

where, sᵢrepresents the number of years of operation for the in-service nuclear power plant 3; sᵢ=1 represents the first year of operation of the in-service nuclear power plant 3, i.e., the first historical year of operation; sᵢ=2 represents the second year of operation of the in-service nuclear power plant 3, i.e., the second historical year of operation; sᵢ=3 represents the third year of operation of the in-service nuclear power plant 3, i.e., the third historical year of operation; sᵢ=4 represents the fourth year of operation of the in-service nuclear power plant 3, i.e., the fourth historical year of operation; sᵢ=5 represents the fifth year of operation of the in-service nuclear power plant 3, i.e., the fifth historical year of operation; and sᵢ=6 represents the sixth year of operation of the in-service nuclear power plant 3, i.e., the sixth historical year of operation.

where E_{AF} (sᵢ) represents the second equivalent availability factor of the in-service nuclear power plant 3 in the historical year of operation sᵢ; P_{OF}(sᵢ) represents the second planned shutdown factor of the in-service nuclear power plant 3 in the historical year of operation sᵢ, 1≤i≤M, M and i are positive integers, M represents the cumulative number of years of operation, M≥5.

In step S404, based on the second equivalent availability factor and the second planned shutdown factor of the in-service nuclear power plant in an i^{th} historical years of operation, the second planned outage-deducting equivalent availability factor of the in-service nuclear power plant in the i^{th} historical years of operation is obtained, where i is a positive integer.

The second planned outage-deducting equivalent availability factor E_{AP}(sᵢ) of the in-service nuclear power plant 3 in the i^{th} historical years of operation is calculated as follows:

$${E}_{AP} ( {s}_{i} ) = \frac{{E}_{AF} ( {s}_{i} )}{1 - {P}_{OF} ( {s}_{i} )} .$$

The calculation results of the second planned outage-deducting equivalent availability factor E_{AP}(tᵢ) of the in-service nuclear power plant 3 in the past 6 years are shown in Table 3.

In step S405, a planned outage-deducting maintenance factor of the source in-service nuclear power plant in the i^{th} historical year of operation is obtained based on the second planned outage-deducting equivalent availability factor of the source in-service nuclear power plant in the i^{th} historical year of operation.

For example, the planned outage-deducting maintenance factor ρ(sᵢ) of the in-service nuclear power plant in the i^{th} historical years sᵢ of operation is calculated as follows:

$$ρ ( {s}_{i} ) = \frac{1 - {E}_{AP} ( {s}_{i} )}{{E}_{AP} ( {s}_{i} )} .$$

The calculation results of the planned outage-deducting maintenance factors ρ(sᵢ) of the source in-service nuclear power plant 3 in the past 6 years are shown in Table 3.

In step S406, a power function expression of the planned outage-deducting maintenance factor of the in-service nuclear power plant is obtained based on the planned outage-deducting maintenance factor of the in-service nuclear power plant in the plurality of historical years of operation.

In step S407, the planned outage-deducting maintenance factor of the in-service nuclear power plant in the current year of operation is obtained based on the power function expression.

It is noted that the power function expression is not limited in the present disclosure. For example, the power function expression may be as follows:

$$ρ ( {s}_{i} ) = α {s}_{i}^{- β} .$$

where, α is a scale parameter of the power function, β is a growth factor of the power function, and sᵢ is the number of years of the operation of the in-service nuclear power plant.

In some embodiments, according to a nonlinear regression method and a least squares method, using the planned outage-deducting maintenance factors ρ(sᵢ) of the in-service nuclear power plant 3 in the past 6 years in Table 3, the power function of the planned outage-deducting maintenance factor of the in-service nuclear power plant 3 is expressed as follows:

$$ρ ( {s}_{i} ) = α {s}_{i}^{- β} = 0.002229 {s}_{i}^{- 3.167142} .$$

That is, α=0.002229, and β=3.167142.

It is seen that the current year of operation of the in-service nuclear power plant 3 is the 7^{th} year of operation of the in-service nuclear power plant 3, i.e. sᵢ=7. The planned outage-deducting maintenance factor ρ(sᵢ) of the in-service nuclear power plant 3 in the current year of operation is calculated as follows:

$$ρ ( {s}_{i} ) = 0.002229 \times {7}^{- 3.167142} .$$

In step S408, reliability prediction values of the in-service nuclear power plants under different planned maintenance categories are obtained based on the planned outage-deducting maintenance factor of the in-service nuclear power plants in the current year of operation.

In some embodiments, based on the planned outage-deducting maintenance factor of the in-service nuclear power plants in the current year of operation, the reliability prediction values of the in-service nuclear power plants in different planned maintenance categories are obtained, which includes inputting the planned outage-deducting maintenance factor into the reliability prediction model, and outputting the reliability prediction values of the in-service nuclear power plants in different planned maintenance categories by the reliability prediction model.

In some embodiments, based on the planned outage-deducting maintenance factor of the in-service nuclear power plants in the current year of operation, obtaining the reliability prediction values of the in-service nuclear power plants in different planned maintenance categories may include the following processes.

In a first process, if the planned maintenance category only includes conventional island planned overhaul, the reliability prediction value for the in-service nuclear power plants in the year of conventional island planned overhaul is obtained based on the planned outage-deducting maintenance factor, conventional islands planned overhaul days and newly added unplanned maintenance days of the in-service nuclear power plant.

For example, if the planned maintenance category of the in-service nuclear power plant 3 in the current year of operation only includes conventional island planned maintenance, the conventional islands planned overhaul days for the in-service nuclear power plant 3 in the current year of operation is m₁=70 days, and the newly added unplanned maintenance days of the in-service nuclear power plant 2 in the current year of operation is Δu_{d}=7 days, and sᵢ=7, a prediction value of the equivalent availability factor E_{AF2}(sᵢ) of the in-service nuclear power plant 3 in the conventional island planned overhaul year is calculated as follows:

$$\begin{matrix}{E}_{A F 2} ( {s}_{i} ) = \frac{1}{1 + α {s}_{i}^{- β}} ( 1 - \frac{24 {m}_{1}}{8760} ) - \frac{24 Δ {u}_{d}}{8760} \\ = \frac{1}{1 + 0.002229 \times {7}^{- 3.167142}} ( 1 - \frac{24 \times 77}{8760} ) - \frac{24 \times 7}{8760} \\ = 0.7699 .\end{matrix}$$

In a second process, if the planned maintenance category only includes nuclear island refueling overhaul, the reliability prediction value of the in-service nuclear power plants in the year of nuclear island refueling overhaul is obtained based on the planned outage-deducting maintenance factor, the number of days of nuclear island refueling overhaul of the in-service nuclear power plants, and the newly added unplanned maintenance days.

For example, if the planned maintenance category of the in-service nuclear power plant 3 in the current year of operation only includes nuclear island refueling overhaul, and the number of days for nuclear island refueling overhaul of the in-service nuclear power plant 3 in the current year of operation is m₂=40 days, the newly added unplanned maintenance days of the in-service nuclear power plant 3 in the current year of operation Δu_{d}=7 days, and sᵢ=7, a prediction value of the equivalent availability factor E_{AF3}(sᵢ) of the in-service nuclear power plant 3 in the nuclear island refueling outage year is calculated as follows:

$$\begin{matrix}{E}_{AF 2} ( {s}_{i} ) = \frac{1}{1 + α {s}_{i}^{- β}} ( 1 - \frac{24 {m}_{2}}{8760} ) - \frac{24 Δ {u}_{d}}{8760} \\ = \frac{1}{1 + 0.002229 \times {7}^{- 3167142}} ( 1 - \frac{24 \times 40}{8760} ) - \frac{24 \times 7}{8760} \\ = 0.8712 .\end{matrix}$$

In a third process, if the planned maintenance category only includes holiday planned maintenance, the reliability prediction value of the in-service nuclear power plants in holiday planned maintenance years is obtained based on the planned outage-deducting maintenance factor, the holiday planned maintenance days of the in-service nuclear power plants, and the newly added unplanned maintenance days.

For example, if the planned maintenance category of the in-service nuclear power plant 3 in the current year of operation only includes holiday planned maintenance, and the planned holiday maintenance days of the in-service nuclear power plant 3 in the current year of operation m₃=15 days, the newly added unplanned maintenance days of the in-service nuclear power plant 3 in the current year of operation Δu_{d}=7 days, and sᵢ=7, the prediction value of the equivalent availability factor E_{AF2}(sᵢ) of the in-service nuclear power plant 3 under holiday planned maintenance is calculated as follows:

$$\begin{matrix}{E}_{AF 2} ( {s}_{i} ) = \frac{1}{1 + α {s}_{i}^{- β}} ( 1 - \frac{24 {m}_{3}}{8760} ) - \frac{24 Δ {u}_{d}}{8760} \\ = \frac{1}{1 + 0.002 \; 229 \times {7}^{- 3.167142}} ( 1 - \frac{24 \times 15}{8760} ) - \frac{24 \times 7}{8760} \\ = 0.9397 .\end{matrix}$$

In a fourth process, if the planned maintenance category is unplanned maintenance category, the reliability prediction value of the in-service nuclear power plants in unplanned maintenance years is obtained based on the planned outage-deducting maintenance factor and the newly added unplanned maintenance days of the in-service nuclear power plants.

For example, if the planned maintenance category of the in-service nuclear power plant 3 is unplanned maintenance category in the current year of operation, the newly added unplanned maintenance days of the in-service nuclear power plant 3 in the current year of operation is Δu_{d}=10 days, and sᵢ=7, a prediction value of the equivalent availability factor E_{AF2}(sᵢ) of the in-service nuclear power plant 3 in the unplanned maintenance year is calculated as follows:

$$\begin{matrix}{E}_{A F 2} ( {s}_{i} ) = \frac{1}{1 + α {s}_{i}^{- β}} - \frac{24 Δ {u}_{d}}{8760} \\ = \frac{1}{1 + 0.002229 \times {7}^{- 3.167142}} - \frac{24 \times 12}{8760} \\ = 0.9671 .\end{matrix}$$

In step S410, based on the second planned outage-deducting equivalent availability factor and the second planned outage factor of the in-service nuclear power plate in the i^{th} historical year of operation, the reliability prediction value of the in-service nuclear power plate in the i^{th} historical year of operation is obtained.

In step S411, based on the relative error between the reliability prediction value and the reliability characteristic quantity statistical value of the in-service nuclear power plate in the same historical year of operation, prediction accuracy verification is performed on the reliability prediction value of the in-service nuclear power plant.

In step S411, if the reliability prediction value of the in-service nuclear power plate does not pass the prediction accuracy verification, the process of obtaining the reliability prediction value of the in-service nuclear power plate is returned until the obtained reliability prediction value of the in-service nuclear power plate passes the prediction accuracy verification.

Therefore, the method may perform prediction accuracy verification on the reliability prediction values of the in-service nuclear power plates, and return to the process of obtaining the reliability prediction values of the in-service nuclear power plates when the reliability prediction values do not pass the prediction accuracy verification until the obtained reliability prediction values of the in-service nuclear power plates pass the prediction accuracy verification. That is, the process of obtaining the reliability prediction values of the in-service nuclear power plates may be repeated until the prediction accuracy of reliability prediction values of the in-service nuclear power plates is relatively high, which helps to achieve high-precision prediction of reliability prediction values for the in-service nuclear power plates.

For example, in the in-service nuclear power plant group 3, the relative error Eᵣ₂ between the prediction value of the equivalent availability factor E_{AF2}(sᵢ) and the statistical value of the second equivalent availability factor E_{AF}(sᵢ) of the in-service nuclear power plant 3 in the i^{th} historical year of operation sᵢ is calculated as follows:

$$\begin{matrix}{E}_{r 2} = \frac{{E}_{AF 2} ( {s}_{i} ) - {E}_{AF} ( {s}_{i} )}{{E}_{AF} ( {s}_{i} )} \\ = \frac{E ( {s}_{i} ) [ 1 - {P}_{OF} ( {s}_{i} ) ] - {E}_{AF} ( {s}_{i} )}{{E}_{AF} ( {s}_{i} )} \times 100 \% \\ = \frac{[ 1 - {P}_{OF} ( {s}_{i} ) ] \div ( 1 + α {s}_{i}^{- β} ) - {E}_{AF} ( {s}_{i} )}{{E}_{AF} ( {s}_{i} )} \times 100 \% .\end{matrix}$$

The calculation results of the relative error Eᵣ₂ between the prediction value of equivalent availability factor E_{AF2}(sᵢ) and the statistical value E_{AF}(sᵢ) of the second equivalent availability factor of the in-service nuclear power plate 3 in the i^{th} historical year of operation sᵢ are shown in Table 4.

TABLE 4
Calculation results of relative error of in-service nuclear power plate 3 in last 6 years

| year of | | | E_{AF2}(sᵢ)) = E_{AF2}(sᵢ) [1 − | | |
|---|---|---|---|---|---|
| operation sᵢ | E_{AP}(sᵢ) | P_{OF}(sᵢ) | P_{OF}(sᵢ)] | E_{AF}(sᵢ) | Eᵣ₂/% |
| 1 2 3 | $\frac{1}{1 + 0.002229 \times {s}_{i}^{- 3.167142}}$ | 0.0827 0.0971 0 | 0.9152 0.9027 0.9999 | 0.9171 0.9022 0.9969 | −0.20 0.05 0.30 |
| 4 | | 0.0820 | 0.9180 | 0.9178 | 0.02 |
| 5 | | 0.0958 | 0.9042 | 0.9042 | −0.03 |
| 6 | | 0 | 1.0000 | 1.0000 | 0 |

In some embodiments, based on the relative error between the reliability prediction values and the reliability characteristic statistics of the in-service nuclear power plates in the same historical year of operation, the prediction accuracy of the reliability prediction values of the in-service nuclear power plates is verified, which includes determining the reliability prediction value of the in-service nuclear power plant through prediction accuracy verification in case that the absolute values of the relative error of the in-service nuclear power plates in the plurality of historical years of operation are less than or equal to a second set threshold, or determining the reliability prediction value of the in-service nuclear power plant through prediction accuracy verification in case that the absolute value of the relative error of the in-service nuclear power plant in at least one historical year of operation is greater than the second set threshold.

Continuing with Table 4 as an example, if the second set threshold is 1.90%, it can be seen from Table 4 that the absolute values of the relative errors of the in-service nuclear power plant group 3 in the past 5 years are all less than 0.35%. It is determined that the prediction value of the equivalent availability factor of the in-service nuclear power plant 3 has been verified through prediction accuracy verification.

In step S412, based on the reliability prediction values and the planned maintenance categories of the in-service nuclear power plates, reliability monitoring is performed on the in-service nuclear power plates.

The relevant content of step S412 may be found in the above-mentioned embodiments, which will not be repeated here.

In summary, according to the method for high-precision predicting and monitoring reliability suitable for an in-service nuclear power plant in embodiments of the present disclosure, the second planned outage-deducting equivalent availability factor of the in-service nuclear power plates in the i^{th} historical year of operation is obtained based on the second equivalent availability factor and the second planned shutdown factor of the in-service nuclear power plates in the i^{th} historical year of operation. The planned outage-deducting equivalent availability factor of the in-service nuclear power plates in the i^{th} historical year of operation is obtained based on the second planned outage-deducting equivalent availability factor of the nuclear power plates in-service in the i^{th} historical year of operation. The power function expression of the planned outage-deducting equivalent availability factor of the in-service nuclear power plates is obtained based on the planned outage-deducting equivalent availability factor of the in-service nuclear power plates in the plurality of historical year of operation. The planned outage-deducting equivalent availability factor of the in-service nuclear power plates in the current year of operation based on the power function expression. The reliability prediction values of the in-service nuclear power plates under different planned maintenance categories are obtained based on the planned outage-deducting equivalent availability factor of the in-service nuclear power plates in the current year of operation, which is suitable for high-precision reliability prediction of the second reliability prediction category of the in-service nuclear power plates.

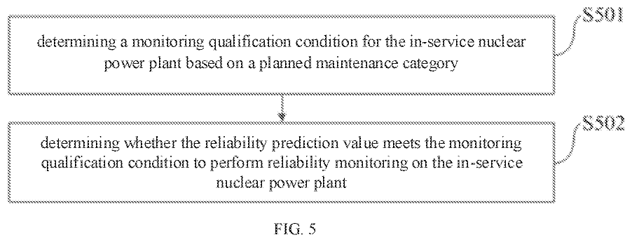

Based on any of the above-mentioned embodiments, as shown in FIG. 5, in step S104, performing reliability monitoring on the in-service nuclear power plant based on a reliability prediction value and a planned maintenance category of the in-service nuclear power plant includes the following steps S501 to S502.

In step S501, a monitoring qualification condition for the in-service nuclear power plant is determined based on the planned maintenance category.

In some embodiments, determining the monitoring qualification condition for the in-service nuclear power plant based on the planned maintenance category includes: determining the monitoring qualification condition for the in-service nuclear power plant based on a corresponding relationship between the planned maintenance categories and the monitoring qualification condition. It is understood that different planned maintenance categories may correspond to different monitoring qualification conditions or the same monitoring qualification conditions.

In some embodiments, determining the monitoring qualification condition for the in-service nuclear power plant based on the planned maintenance category includes: determining a reliability monitoring criterion value of the in-service nuclear power plant based on the planned maintenance category; and determining the monitoring qualification condition based on the reliability monitoring criterion value.

In some embodiments, determining the reliability monitoring criterion value for the in-service nuclear power plant based on the planned maintenance category includes: determining the reliability monitoring criterion value for the in-service nuclear power plant based on the corresponding relationship between the planned maintenance category and the reliability monitoring criterion value.

In some embodiments, determining the monitoring qualification condition for the in-service nuclear power plant based on the reliability monitoring criterion value includes determining that the target reliability prediction value is greater than or equal to the reliability monitoring criterion value as the monitoring qualification condition.

In some embodiments, determining the monitoring qualification condition for the in-service nuclear power plants based on the reliability monitoring criterion value includes determining that the target reliability prediction value is less than the reliability monitoring criterion value as a monitoring failure condition.

In step S502, it is determined whether the reliability prediction value meets the monitoring qualification condition to perform reliability monitoring on the in-service nuclear power plant.

In some embodiments, determining whether the reliability prediction value meets the monitoring qualification condition to perform reliability monitoring on the in-service nuclear power plant included determining that there is no reliability anomaly in the in-service nuclear power plant in case that the reliability prediction value meets the monitoring qualification conditions, and determining that reliability abnormalities occur in the in-service nuclear power plant in case that the reliability prediction value does not meet the monitoring qualification conditions.

For example, if the reliability prediction value is greater than or equal to the reliability monitoring criterion value based on the monitoring qualification condition, determining whether the reliability prediction value meets the monitoring qualification condition to perform reliability monitoring on the in-service nuclear power plant includes determining that there is no reliability anomaly in the in-service nuclear power plant if the reliability prediction value is greater than or equal to the reliability monitoring criterion value, and determining that there are reliability abnormalities in the in-service nuclear power plant if the reliability prediction value is less than the reliability monitoring criterion value.

Therefore, in the method, based on the planned maintenance category, the monitoring qualification conditions for the in-service nuclear power plants are determined, and the target reliability prediction value is determined to meet the monitoring qualification conditions for reliability monitoring of the in-service nuclear power plants. That is, the planned maintenance category may be considered to determine the monitoring qualification conditions to preform reliability monitoring on the in-service nuclear power plant.

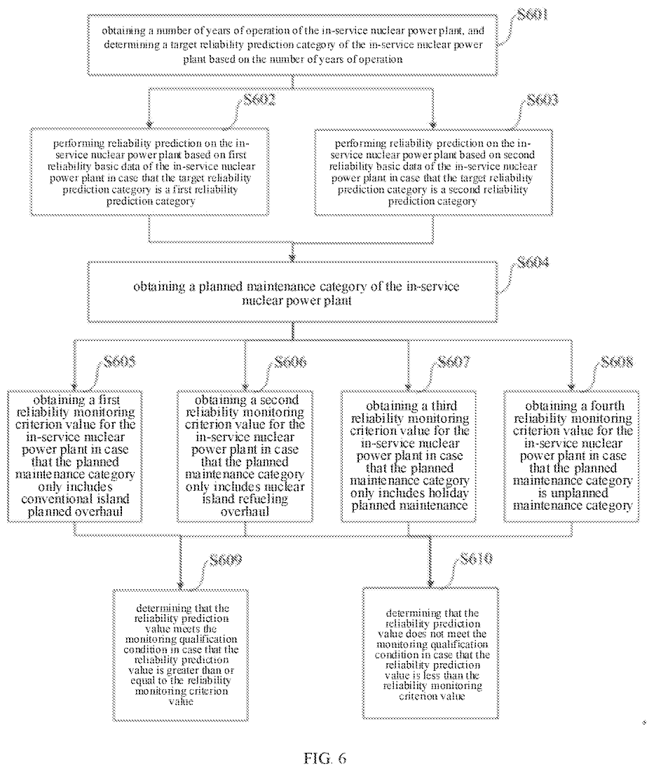

FIG. 6 is a flowchart showing a method for predicting and monitoring reliability suitable for an in-service nuclear power plant according to an embodiment of the present disclosure.

As shown in FIG. 6, the method for predicting and monitoring reliability suitable for the in-service nuclear power plant in embodiments of the present disclosure includes the following step S601 and S610.

In step S601, a number of years of operation of the in-service nuclear power plant is obtained, and a target reliability prediction category of the in-service nuclear power plant is determined based on the number of years of operation.

In step S602, reliability prediction is performed on the in-service nuclear power plant based on first reliability basic data of the in-service nuclear power plant in case that the target reliability prediction category is a first reliability prediction category.

In step S603, reliability prediction is performed on the in-service nuclear power plant based on second reliability basic data of the in-service nuclear power plant in case that the target reliability prediction category is a second reliability prediction category.

In step S604, a planned maintenance category for the in-service nuclear power plants is obtained.

In step S605, in case that the planned maintenance category only includes conventional island planned overhaul, a first reliability monitoring criterion value for the in-service nuclear power plant is obtained.

In step S606, in case that the planned maintenance category only includes nuclear island refueling overhaul, a second reliability monitoring criterion value for the in-service nuclear power plant is obtained.

In step S607, in case that the planned maintenance category only includes holiday planned maintenance, a third reliability monitoring criterion value for the in-service nuclear power plant is obtained.

In step S608, in case that the planned maintenance category is unplanned maintenance category, a fourth reliability monitoring criterion value for the in-service nuclear power plant is obtained.

In step S609, in case that the reliability prediction value is greater than or equal to the reliability monitoring criterion value, it is determined that the reliability prediction value meets the monitoring qualification condition.

In step S610, in case that the reliability prediction value is less than the reliability monitoring criterion value, it is determined that the reliability prediction value does not meet the monitoring qualification condition.

In some embodiments, in case that the reliability prediction category of the in-service nuclear power plant 1 is the first reliability prediction category, reliability monitoring of the in-service nuclear power plant 1 is performed as follows.

For example, if the power of the in-service nuclear power plant 1 is 1000 MW and has been in operation for 4 years but less than 5 years, the reliability characteristic quantity is taken as the equivalent availability factor, the equivalent availability factor of the in-service nuclear power plant 1 may be predicted in the current year of operation, and the prediction value of the equivalent availability factor E_{AF1}(tᵢ) may be obtained, where tᵢ, is the current year of operation.

In some embodiments, the reliability monitoring criteria for the in-service nuclear power plant 1 are shown in Table 5.

TABLE 5
Reliability monitoring criteria for in-service nuclear power plants

| number | reliability monitoring criterion value | value |
|---|---|---|
| 1 | first reliability monitoring criterion value E_{AF01} | 0.77 |
| 2 | second reliability monitoring criterion value E_{AF02} | 0.87 |
| 3 | third reliability monitoring criterion value E_{AF03} | 0.91 |
| 4 | fourth reliability monitoring criterion value E_{AF04} | 0.94 |

If the planned maintenance category only includes conventional island planned overhaul, the prediction value of equivalent availability factor EAF1(tᵢ)=0.7597, and E_{AF1}(tᵢ)<E_{AF01}, it is determined that the prediction value of equivalent availability factor E_{AF1}(tᵢ) does not meet the monitoring qualification condition.

If the planned maintenance category only includes nuclear island refueling overhaul, the prediction value of equivalent availability factor E_{AF1}(tᵢ)=0.8574, and E_{AF1}(tᵢ)<E_{AF02}, it is determined that the prediction value of equivalent availability factor E_{AF1}(tᵢ) does not meet the monitoring qualification conditions.

If the planned maintenance category only includes holiday planned maintenance, the prediction value of equivalent availability factor E_{AF1}(tᵢ)=0.9076, and E_{AF1}(tᵢ)<E_{AF03}, it can be determined that the prediction value of equivalent availability factor E_{AF1}(tᵢ) does not meet the monitoring qualification conditions.

If the planned maintenance category is unplanned maintenance category, the prediction value of equivalent availability factor E_{AF1}(tᵢ)=0.7597, and E_{AF1}(tᵢ)<E_{AF04}, it can be determined that the prediction value of equivalent availability factor E_{AF1}(tᵢ) does not meet the monitoring qualification conditions.

In some embodiments, if the reliability prediction category of the in-service nuclear power plant 3 is the second reliability prediction category, reliability monitoring on the in-service nuclear power plant 3 is performed as follows.

For example, a power of the in-service nuclear power plant is 1100 MW and a total of 6 years of operation but less than 7 years, the reliability characteristic quantity is used as an equivalent availability factor, the equivalent availability factor of the in-service nuclear power plant 3 may be predicted in the current year of operation, and the prediction value of the equivalent availability factor E_{AF2}(sᵢ) may be obtained, where sᵢ, is the number of years of operation of the in-service nuclear power plant 3, and sᵢ=7 refers to the 7th year of operation of the in-service nuclear power plant 3, that is the current year of operation.

In some embodiments, the reliability monitoring criteria for the in-service nuclear power plant 3 are shown in Table 5.

If the planned maintenance category only includes conventional island planned overhaul, the prediction value of equivalent availability factor E_{AF2}(sᵢ)=0.7699, and E_{AF2}(sᵢ)<E_{AF01}, it can be determined that the prediction value of equivalent availability factor E_{AF2}(sᵢ) does not meet the monitoring qualification conditions.

If the planned maintenance category only includes nuclear island refueling overhaul, the prediction value of the equivalent availability factor E_{AF2}(sᵢ)=0.8712, and E_{AF2}(sᵢ)>E_{AF02}, it can be determined that the prediction value of the equivalent availability factor E_{AF2}(sᵢ) meets the monitoring qualification conditions.

If the planned maintenance category only includes holiday planned maintenance, the prediction value of equivalent availability factor E_{AF2}(sᵢ)=0.9397, and E_{AF2}(sᵢ)>E_{AF03}, it can be determined that the prediction value of equivalent availability factor E_{AF2}(sᵢ) meets the monitoring qualification condition.

If the planned maintenance category is unplanned maintenance category, the prediction value of equivalent availability factor E_{AF2}(sᵢ)=0.9671, and E_{AF2}(sᵢ)>E_{AF04}, it can be determined that the prediction value of equivalent availability factor E_{AF2}(sᵢ) meets the monitoring qualification condition.

In summary, according to the method for high-precision predicting and monitoring reliability suitable for the in-service nuclear power plant in embodiments of the present disclosure, if the planned maintenance category only includes conventional island planned maintenance, the first reliability monitoring criterion value is obtained. If the planned maintenance category only includes nuclear island refueling overhaul, the second reliability monitoring criterion value is obtained. If the planned maintenance category only includes holiday planned maintenance, the third reliability monitoring criterion value is obtained. If the planned maintenance category is unplanned maintenance, the fourth reliability monitoring criterion value is obtained. Based on the relationship between the obtained reliability monitoring criterion value and the reliability prediction value, it is determined whether the reliability prediction value meets the monitoring qualification condition, which is suitable to perform reliability monitoring of the in-service nuclear power plants.

FIG. 7 is a flowchart showing a method for increasing reliability suitable for an in-service nuclear power plant according to an embodiment of the present disclosure.

As shown in FIG. 7, the method for increasing reliability suitable for the in-service nuclear power plant in embodiments of the present disclosure includes the following steps S701 to S703.

In step S701, reliability prediction is performed on the in-service nuclear power plant based on a number of years of operation of the in-service nuclear power plant to obtain a reliability prediction value of the in-service nuclear power plant;

The relevant content of step S701 may be found in FIG. 1 to FIG. 4 of the following embodiments, which will not be repeated here.

In step S702, abnormal reliability data of the in-service nuclear power plant is determined based on a planned maintenance category of the in-service nuclear power plant in case that the reliability prediction value does not meet a monitoring qualification condition.

It is noted that there are not too many limitation on abnormal reliability data. For example, abnormal reliability data includes planned maintenance days corresponding to planned maintenance categories and/or newly added unplanned maintenance days for the in-service nuclear power plants.

In some embodiments, determining abnormal reliability data of the in-service nuclear power plant based on the planned maintenance category includes determining abnormal reliability data based on the corresponding relationship between the planned maintenance category and abnormal reliability data. It is understood that different planned maintenance categories may correspond to different abnormal reliability data or the same abnormal reliability data.

In step S703, the abnormal reliability data is optimized, and a process of obtaining the reliability prediction value is returned to perform until the reliability prediction value obtained meets the monitoring qualification condition.

In some embodiments, optimizing abnormal reliability data includes determining an optimization strategy for abnormal reliability data based on the planned maintenance categories, and optimizing the abnormal reliability data according to the optimization strategy. Therefore, the method may consider the planned maintenance category and determine the optimization strategy for the abnormal reliability data, so as to optimize the abnormal reliability data and improve the accuracy of optimization of the abnormal reliability data.

In some embodiments, optimizing the abnormal reliability data includes determining an adjustment interval for planned maintenance days based on the planned maintenance category, optimizing the planned maintenance days within the adjustment interval, determining an adjustment interval for newly added unplanned maintenance days, and optimizing the newly added unplanned maintenance days within the adjustment interval for new unplanned maintenance days.

In some embodiments, a mapping relationship between the planned maintenance category and the adjustment interval of the planned maintenance days may be established in advance. Determining the adjustment interval of the planned maintenance days based on the planned maintenance category includes querying the adjustment interval in the mapping relationship based on the planned maintenance category, and determining the queried adjustment interval as the adjustment interval of the planned maintenance days.

In summary, according to the method for high-precision increasing reliability for the in-service nuclear power plant in embodiments of the present disclosure, if the reliability prediction value does not meet the monitoring qualification conditions, the abnormal reliability data of the in-service nuclear power plant is determined based on the planned maintenance category, the abnormal reliability data is optimized, and the process of obtaining the reliability prediction value is returned to perform until the obtained reliability prediction value meets the monitoring qualification conditions. Therefore, when the reliability prediction value does not meet the monitoring qualification conditions, the abnormal reliability data may be optimized, and the process of obtaining the reliability prediction value may be returned to execute until the obtained reliability prediction value meets the monitoring qualification conditions, which may improve the reliability of the in-service nuclear power plant.

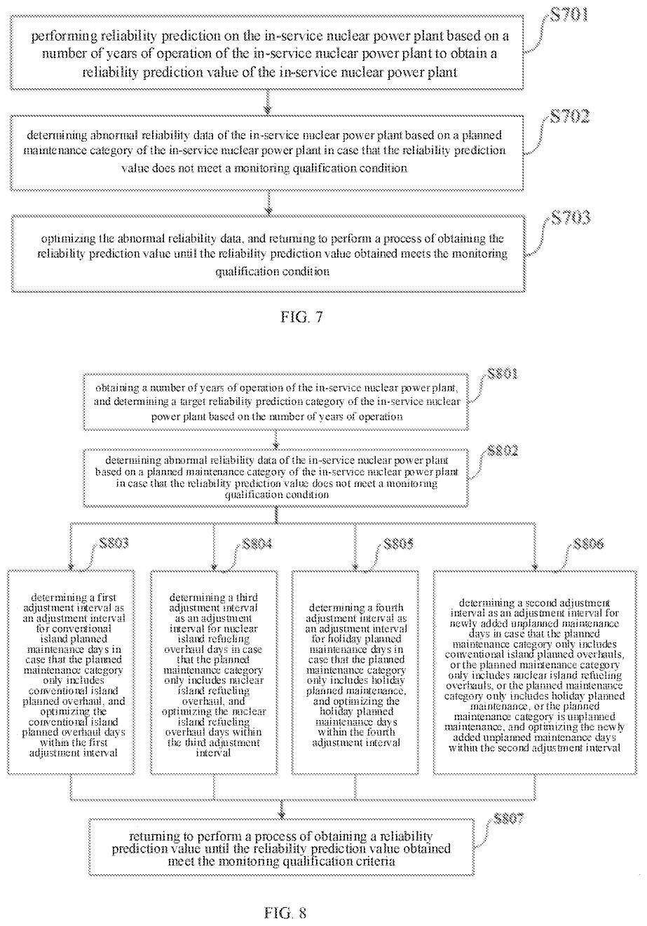

FIG. 8 is a flowchart showing a method for high-precision increasing reliability suitable for an in-service nuclear power plant according to an embodiment of the present disclosure.

As shown in FIG. 8, the method for high-precision increasing reliability for the in-service nuclear power plant in embodiments of the present disclosed e includes the following steps S801 to S807.

In step S801, reliability prediction is performed on the in-service nuclear power plant based on a number of years of operation of the in-service nuclear power plant to obtain a reliability prediction value of the in-service nuclear power plant;

In step S802, abnormal reliability data of the in-service nuclear power plant is determined based on a planned maintenance category of the in-service nuclear power plant in case that the reliability prediction value does not meet a monitoring qualification condition.

The relevant content of steps S801 to S802 may be found in the above-mentioned embodiments, which will not be repeated here.

In step S803, in case that the planned maintenance category only includes conventional island planned overhaul, a first adjustment interval is determined as an adjustment interval for conventional island planned maintenance days, and the conventional island planned overhaul days within the first adjustment interval is optimized.

In step S804, in case that the planned maintenance category only includes nuclear island refueling overhaul, a third adjustment interval is determined as an adjustment interval for nuclear island refueling overhaul days, and the nuclear island refueling overhaul days within the third adjustment interval is optimized.

In step S805, in case that the planned maintenance category only includes holiday planned maintenance, a fourth adjustment interval is determined as an adjustment interval for holiday planned maintenance days, and the holiday planned maintenance days within the fourth adjustment interval is optimized.

In step S806, in case that the planned maintenance category only includes conventional island planned overhaul, or the planned maintenance category only includes nuclear island refueling overhaul, or the planned maintenance category only includes holiday planned maintenance, or the planned maintenance category is unplanned maintenance, a second adjustment interval is determined as an adjustment interval for newly added unplanned maintenance days, and the newly added unplanned maintenance days within the second adjustment interval is optimized.

In step S807, the process of obtaining reliability prediction values is returned to perform until the obtained reliability prediction values meet the monitoring qualification criteria.

In some embodiments, if the reliability prediction category of the in-service nuclear power plant 1 is the first reliability prediction category, the method for increasing reliability for the in-service nuclear power plant 1 is performed as follows.

For example, the reliability characteristic quantity is the equivalent availability factor.

Manner 1: If the planned maintenance category only includes conventional island planned overhaul, a lower limit of the first adjustment interval is greater than or equal to 60 days, an upper limit of the first adjustment interval is less than or equal to 80 days. A lower limit of the second adjustment interval is greater than or equal to 1 day, and an upper limit of the second adjustment interval is less than or equal to 12 days.

The target equivalent availability factors E_{AF1}(tᵢ) of the in-service nuclear power plant 1 corresponding to different conventional islands planned overhaul days m₁, and newly added unplanned maintenance days Δu_{d} are shown in Table 6.

TABLE 6
E_{AF1}(tᵢ) corresponding to different m₁ and
Δu_{d} of the in-service nuclear power plant 1

| conventional | | | | | | |
|---|---|---|---|---|---|---|
| islands planned | | | | | | |
| overhaul | newly added unplanned maintenance days Δu_{d} | | | | | |
| days m₁ | 2 | 3 | 4 | 5 | 6 | 7 |
| 66 | 0.7840 | 0.7812 | 0.7785 | 0.7758 | 0.7730 | 0.7703 |
| 67 | 0.7813 | 0.7786 | 0.7759 | 0.7731 | 0.7704 | 0.7676 |
| 68 | 0.7787 | 0.7760 | 0.7732 | 0.7705 | 0.7677 | 0.7650 |
| 69 | 0.7760 | 0.7733 | 0.7706 | 0.7678 | 0.7651 | 0.7624 |
| 70 | 0.7734 | 0.7707 | 0.7679 | 0.7652 | 0.7625 | 0.7597 |

As shown in Table 6, it is seen that optimizing abnormal reliability data in only conventional island planned overhaul years includes the following implements.

In a first improvement, the planned conventional island overhaul days m₁ for the in-service nuclear power plant 1 is adjusted to 66 days, the newly added unplanned overhaul days Δu_{d} is determined as 1 to 7 days, and the newly added unplanned maintenance days Δu_{d} for the in-service nuclear power plant 1 is optimized within the range of 1 to 7 days.

In a second improvement, the planned conventional island overhaul days m₁ for the in-service nuclear power plant 1 is adjusted to 67 days, the newly added unplanned overhaul days Δu_{d} is determined as 1 to 6 days, and the newly added unplanned maintenance days Δu_{d} for the in-service nuclear power plant 1 is optimized within the range of 1 to 6 days.

In a third improvement, the planned conventional island overhaul days m₁ for the in-service nuclear power plant 1 is adjusted to 68 days, the newly added unplanned overhaul days Δu_{d} is determined as 1 to 5 days, and the newly added unplanned maintenance days Δu_{d} for the in-service nuclear power plant 1 is optimized within the range of 1 to 5 days.

In a fourth improvement, the planned conventional island overhaul days m₁ for the in-service nuclear power plant 1 is adjusted to 69 days, the newly added unplanned overhaul days Δu_{d} is determined as 1 to 4 days, and the newly added unplanned maintenance days Δu_{d} for the in-service nuclear power plant 1 is optimized within the range of 1 to 4 days.

In a fifth improvement, the planned conventional island overhaul days m₁ for the in-service nuclear power plant 1 is adjusted to 70 days, the newly added unplanned overhaul days Δu_{d} is determined as 1 to 3 days, and the newly added unplanned maintenance days Δu_{d} for the in-service nuclear power plant 1 is optimized within the range of 1 to 3 days.

Manner 2: if the planned maintenance category only includes nuclear island refueling overhaul, a lower limit of the third adjustment interval is greater than or equal to 20 days, an upper limit of the third adjustment interval is less than or equal to 40 days, a lower limit of the second adjustment interval is greater than or equal to 1 day, and an upper limit of the second adjustment interval is less than or equal to 12 days.

The prediction values of the target equivalent availability factor E_{AF1}(tᵢ) of the in-service nuclear power plant 1 corresponding to different nuclear island refueling overhaul days m₂ and newly added unplanned maintenance days Δu_{d} are shown in Table 7.

TABLE 7
E_{AF1}(tᵢ) of in-service nuclear power plant
1corresponding to different Δu_{d} and m₂

| nuclear island | | | | | | |
|---|---|---|---|---|---|---|
| refueling | | | | | | |
| overhaul | newly added unplanned maintenance days Δu_{d} | | | | | |
| days m₂ | 2 | 3 | 4 | 5 | 6 | 7 |
| 29 | 0.8817 | 0.8789 | 0.8762 | 0.8734 | 0.8707 | 0.8680 |
| 30 | 0.8790 | 0.8763 | 0.8735 | 0.8708 | 0.8681 | 0.8653 |
| 31 | 0.8764 | 0.8736 | 0.8709 | 0.8682 | 0.8654 | 0.8627 |
| 32 | 0.8737 | 0.8710 | 0.8683 | 0.8655 | 0.8628 | 0.8600 |
| 33 | 0.8711 | 0.8684 | 0.8656 | 0.8629 | 0.8601 | 0.8574 |

As shown in Table 7, it is seen that abnormal reliability data in only nuclear island refueling overhaul years is optimized by the following implementations.

In a first improvement, the nuclear island refueling overhaul days m₂ for the in-service nuclear power plant 1 is adjusted to 29 days, the newly added unplanned overhaul days Δu_{d} is determined as 1 to 6 days, and the newly added unplanned maintenance days Δu_{d} for the in-service nuclear power plant 1 is optimized within the range of 1 to 6 days.

In a second improvement, the nuclear island refueling overhaul days m₂ for the in-service nuclear power plant 1 is adjusted to 30 days, the newly added unplanned overhaul days Δu_{d} is determined as 1 to 5 days, and the newly added unplanned maintenance days Δu_{d} for the in-service nuclear power plant 1 is optimized within the range of 1 to 5 days.

In a third improvement, the nuclear island refueling overhaul days m₂ for the in-service nuclear power plant 1 is adjusted to 31 days, the newly added unplanned overhaul days Δu_{d} is determined as 1 to 4 days, and the newly added unplanned maintenance days Δu_{d} for the in-service nuclear power plant 1 is optimized within the range of 1 to 4 days.

In a fourth improvement, the nuclear island refueling overhaul days m₂ for the in-service nuclear power plant 1 is adjusted to 32 days, the newly added unplanned overhaul days Δu_{d} is determined as 1 to 3 days, and the newly added unplanned maintenance days Δu_{d} for the in-service nuclear power plant 1 is optimized within the range of 1 to 3 days.

In a fifth improvement, the nuclear island refueling overhaul days m₂ for the in-service nuclear power plant 1 is adjusted to 33 days, the newly added unplanned overhaul days Δu_{d} is determined as 1 to 2 days, and the newly added unplanned maintenance days Δu_{d} for the in-service nuclear power plant 1 is optimized within the range of 1 to 2 days.

Manner 3: If the planned maintenance category only includes holiday planned maintenance, a lower limit of the fourth adjustment interval is greater than or equal to 5 days, an upper limit of the fourth adjustment interval is less than or equal to 15 days, a lower limit of the second adjustment interval is greater than or equal to 1 day, and an upper limit of the second adjustment interval is less than or equal to 12 days.

The prediction values of the target equivalent availability factor E_{AF1}(tᵢ) of in-service nuclear power plant 1 corresponding to different holiday planned maintenance days m₃, and newly added unplanned maintenance days Δu_{d} are shown in Table 8.

TABLE 8
E_{AF1}(tᵢ) of in-service nuclear power plant
1 corresponding to different m₃ and Δ u_{d}

| holiday | | | | | | |
|---|---|---|---|---|---|---|
| planned | | | | | | |
| maintenance | newly added unplanned maintenance days Δu_{d} | | | | | |
| days m₃ | 5 | 6 | 7 | 8 | 9 | 10 |
| 10 | 0.9236 | 0.9209 | 0.9181 | 0.9154 | 0.9126 | 0.9099 |
| 11 | 0.9210 | 0.9182 | 0.9154 | 0.9127 | 0.9100 | 0.9073 |
| 12 | 0.9183 | 0.9156 | 0.9128 | 0.9101 | 0.9074 | 0.9046 |
| 13 | 0.9157 | 0.9129 | 0.9102 | 0.9075 | 0.9047 | 0.9020 |
| 14 | 0.9130 | 0.9103 | 0.9076 | 0.9048 | 0.9021 | 0.8993 |

As shown in Table 8, it is seen that the abnormal reliability data in holidays is optimized by the following implementations.

In a first improvement, the planned holiday maintenance days m₃ for the in-service nuclear power plant 1 is adjusted to 10 days, and an adjustment interval of the newly added unplanned maintenance days Δu_{d} is determined as 1 to 9 days, and the newly added unplanned maintenance days Δu_{d} for the in-service nuclear power plant 1 are improved within 1 to 9 days.

In a second improvement, the planned holiday maintenance days m₃ for the in-service nuclear power plant 1 is adjusted to 11 days, and an adjustment interval of the newly added unplanned maintenance days Δu_{d} is determined as 1 to 9 days, and the newly added unplanned maintenance days Δu_{d} for the in-service nuclear power plant 1 are improved within 1 to 9 days.

In a third improvement, the planned holiday maintenance days m₃ for the in-service nuclear power plant 1 is adjusted to 12 days, and an adjustment interval of the newly added unplanned maintenance days Δu_{d} is determined as 1 to 8 days, and the newly added unplanned maintenance days Δu_{d} for the in-service nuclear power plant 1 are improved within 1 to 8 days.

In a fourth improvement, the planned holiday maintenance days m₃ for the in-service nuclear power plant 1 is adjusted to 13 days, and an adjustment interval of the newly added unplanned maintenance days Δu_{d} is determined as 1 to 7 days, and the newly added unplanned maintenance days Δu_{d} for the in-service nuclear power plant 1 are improved within 1 to 7 days.

In a fifth improvement, the planned holiday maintenance days m₃ for the in-service nuclear power plant 1 is adjusted to 14 days, and an adjustment interval of the newly added unplanned maintenance days Δu_{d} is determined as 1 to 6 days, and the newly added unplanned maintenance days Δu_{d} for the in-service nuclear power plant 1 are improved within 1 to 6 days.

Manner 4: If the planned maintenance category is unplanned maintenance category, a lower limit of the second adjustment interval is greater than or equal to 1 day, and an upper limit of the second adjustment interval is less than or equal to 12 days.

The prediction values of the target equivalent availability factor E_{AF1}(tᵢ) of the in-service nuclear power plant 1 corresponding to different newly added unplanned maintenance days Δu_{d} are shown in Table 9.

TABLE 9
ΔE_{AF1}(tᵢ) of in-service nuclear power plant
1 corresponding to different Δu_{d}

| | newly added unplanned maintenance days Δu_{d} | | | | | |
|---|---|---|---|---|---|---|
| | 1 | 2 | 3 | 4 | 5 | 6 |
| equivalent | 0.9610 | 0.9582 | 0.9555 | 0.9528 | 0.9500 | 0.9473 |
| availability | | | | | | |
| factor E_{AF1}(tᵢ) | | | | | | |
| | newly added unplanned maintenance days Δu_{d} | | | | | |
| | 7 | 8 | 9 | 10 | 11 | 12 |
| equivalent | 0.9445 | 0.9418 | 0.9391 | 0.9363 | 0.9336 | 0.9308 |
| availability | | | | | | |
| factor E_{AF1}(tᵢ) | | | | | | |

As shown in Table 9, the adjustment interval of the newly added unplanned maintenance days Δu_{d} is determined as 1 to 8, and the newly added unplanned maintenance days Δu_{d} for in-service nuclear power plant 1 is optimized within 1 to 8 days.

In some embodiments, if the reliability prediction category of the in-service nuclear power plant 3 is the second reliability prediction category, reliability increasing of the in-service nuclear power plant 3 is performed as follows.

For example, the reliability characteristic quantity is the equivalent availability factor.

Manner 1: If the planned maintenance category only includes conventional island planned overhaul, a lower limit of the first adjustment interval is greater than or equal to 60 days, an upper limit of the first adjustment interval is less than or equal to 80 days, a lower limit of the second adjustment interval is greater than or equal to 1 day, and an upper limit of the second adjustment interval is less than or equal to 12 days.

The prediction values of the target equivalent availability factor E_{AF2}(sᵢ) of in-service nuclear power plant 3 corresponding to different conventional islands planned overhaul days m₁ and newly added unplanned maintenance days Δu_{d} are shown in Table 10.

TABLE 10
ΔE_{AF2}(sᵢ) of in-service nuclear power plant 3 corresponding to different Δu_{d} and m₁

| conventional islands | newly added unplanned maintenance days Δu_{d} | | | | | | |
|---|---|---|---|---|---|---|---|
| planned overhaul days m₁ | 6 | 7 | 8 | 9 | 10 | 11 | 12 |
| 73 | 0.7836 | 0.7808 | 0.7781 | 0.7753 | 0.7726 | 0.7699 | 0.7671 |
| 74 | 0.7808 | 0.7781 | 0.7753 | 0.7726 | 0.7699 | 0.7671 | 0.7644 |
| 75 | 0.7781 | 0.7753 | 0.7726 | 0.7699 | 0.7671 | 0.7644 | 0.7616 |
| 76 | 0.7753 | 0.7726 | 0.7699 | 0.7671 | 0.7644 | 0.7616 | 0.7589 |
| 77 | 0.7726 | 0.7699 | 0.7671 | 0.7644 | 0.7616 | 0.7589 | 0.7562 |

As shown in Table 10, it is seen that the abnormal reliability data in only conventional island planned overhaul years is optimized by the following implementations.

In a first improvement, the conventional island planned overhaul days m₁ for in-service nuclear power plant is adjusted to 73 days, and an adjustment interval of the newly added unplanned maintenance days Δu_{d} is determined as 1 to 10 days, and the newly added unplanned maintenance days Δu_{d} for in-service nuclear power plant 3 is optimized within 1 to 10 days.

In a second improvement, the conventional island planned overhaul days m₁ for in-service nuclear power plant is adjusted to 74 days, and an adjustment interval of the newly added unplanned maintenance days Δu_{d} is determined as 1 to 9 days, and the newly added unplanned maintenance days Δu_{d} for in-service nuclear power plant 3 is optimized within 1 to 9 days.

In a third improvement, the conventional island planned overhaul days m₁ for in-service nuclear power plant is adjusted to 75 days, and an adjustment interval of the newly added unplanned maintenance days Δu_{d} is determined as 1 to 8 days, and the newly added unplanned maintenance days Δu_{d} for in-service nuclear power plant 3 is optimized within 1 to 8 days.

In a fourth improvement, the conventional island planned overhaul days m₁ for in-service nuclear power plant is adjusted to 76 days, and an adjustment interval of the newly added unplanned maintenance days Δu_{d} is determined as 1 to 7 days, and the newly added unplanned maintenance days Δu_{d} for in-service nuclear power plant 3 is optimized within 1 to 7 days.

In a fifth improvement, the conventional island planned overhaul days m₁ for in-service nuclear power plant is adjusted to 77 days, and an adjustment interval of the newly added unplanned maintenance days Δu_{d} is determined as 1 to 6 days, and the newly added unplanned maintenance days Δu_{d} for in-service nuclear power plant 3 is optimized within 1 to 6 days.

Manner 2: If the planned maintenance category only includes nuclear island refueling overhaul, a lower limit of the third adjustment interval is greater than or equal to 20 days, an upper limit of the third adjustment interval is less than or equal to 40 days, a lower limit of the second adjustment interval is greater than or equal to 1 day, and an upper limit of the second adjustment interval is less than or equal to 12 days.

The prediction values of the target equivalent availability factor E_{AF2}(sᵢ) of in-service nuclear power plant 3 corresponding to different nuclear island refueling overhaul days m₂ and different newly added unplanned maintenance days Δu_{d} are shown in Table 11.

TABLE 11
ΔE_{AF2}(sᵢ) of in-service nuclear power plant 3 corresponding to different m₂ and Δu_{d}

| nuclear island refueling | newly added unplanned maintenance days Δu_{d} | | | | | | |
|---|---|---|---|---|---|---|---|
| overhaul days m₂ | 6 | 7 | 8 | 9 | 10 | 11 | 12 |
| 36 | 0.8849 | 0.8822 | 0.8794 | 0.8767 | 0.8740 | 0.8712 | 0.8685 |
| 37 | 0.8822 | 0.8794 | 0.8767 | 0.8740 | 0.8712 | 0.8685 | 0.8057 |
| 38 | 0.8794 | 0.8767 | 0.8740 | 0.8712 | 0.8685 | 0.8657 | 0.8630 |
| 39 | 0.8767 | 0.8740 | 0.8712 | 0.8685 | 0.8657 | 0.8630 | 0.8603 |
| 40 | 0.8740 | 0.8712 | 0.8685 | 0.8657 | 0.8630 | 0.8603 | 0.8575 |

As shown in Table 11, it is seen that abnormal reliability data only in nuclear island refueling overhaul years is optimized by the following implementations.

In a first improvement, the nuclear island refueling overhaul days m₂ of in-service nuclear power plant 3 is adjusted to 36 days, and an adjustment interval of the newly added unplanned maintenance days Δu_{d} is determined as 1 to 11 days, and the newly add unplanned maintenance days Δu_{d} for the in-service nuclear power plant 3 is optimized within 1 to 11 days.

In a second improvement, the nuclear island refueling overhaul days m₂ of in-service nuclear power plant 3 is adjusted to 37 days, and an adjustment interval of the newly added unplanned maintenance days Δu_{d} is determined as 1 to 10 days, and the newly add unplanned maintenance days Δu_{d} for the in-service nuclear power plant 3 is optimized within 1 to 10 days.

In a third improvement, the nuclear island refueling overhaul days m₂ of in-service nuclear power plant 3 is adjusted to 38 days, and an adjustment interval of the newly added unplanned maintenance days Δu_{d} is determined as 1 to 9 days, and the newly add unplanned maintenance days Δu_{d} for the in-service nuclear power plant 3 is optimized within 1 to 9 days.

In a fourth improvement, the nuclear island refueling overhaul days m₂ of in-service nuclear power plant 3 is adjusted to 39 days, and an adjustment interval of the newly added unplanned maintenance days Δu_{d} is determined as 1 to 8 days, and the newly add unplanned maintenance days Δu_{d} for the in-service nuclear power plant 3 is optimized within 1 to 8 days.

In a fifth improvement, the nuclear island refueling overhaul days m₂ of in-service nuclear power plant 3 is adjusted to 40 days, and an adjustment interval of the newly added unplanned maintenance days Δu_{d} is determined as 1 to 7 days, and the newly add unplanned maintenance days Δu_{d} for the in-service nuclear power plant 3 is optimized within 1 to 7 days.

Manner 3: If the planned maintenance category only includes holiday planned maintenance, a lower limit of the fourth adjustment interval is greater than or equal to 5 days, an upper limit of the fourth adjustment interval is less than or equal to 15 days, a lower limit of the second adjustment interval is greater than or equal to 1 day, and an upper limit of the second adjustment interval is less than or equal to 12 days.

The prediction values of the target equivalent availability factor E_{AF2}(sᵢ) of in-service nuclear power plant 3 corresponding to different holiday planned maintenance days m₃, and newly added unplanned maintenance days Δu_{d} are shown in Table 12.

TABLE 12
ΔE_{AF2}(sᵢ) of in-service nuclear power plant 3 corresponding to different m₃ and Δu_{d}

| holiday planned | newly added unplanned maintenance days Δu_{d} | | | | | | |
|---|---|---|---|---|---|---|---|
| maintenance days m₃ | 6 | 7 | 8 | 9 | 10 | 11 | 12 |
| 11 | 0.9534 | 0.9507 | 0.9479 | 0.9452 | 0.9425 | 0.9397 | 0.9370 |
| 12 | 0.9507 | 0.9479 | 0.9452 | 0.9425 | 0.9397 | 0.9370 | 0.9342 |
| 13 | 0.9479 | 0.9452 | 0.9425 | 0.9397 | 0.9370 | 0.9342 | 0.9315 |
| 14 | 0.9452 | 0.9425 | 0.9397 | 0.9370 | 0.9342 | 0.9315 | 0.9288 |
| 15 | 0.9425 | 0.9397 | 0.9370 | 0.9342 | 0.9315 | 0.9288 | 0.9260 |

As shown in Table 12, it is seen that abnormal reliability data only in holiday planned maintenance year is optimized the following implementations.

In a first improvement, the planned holiday maintenance days m₃ of the in-service nuclear power plant 3 is adjusted to 11 days, and an adjustment interval of the newly added unplanned maintenance days Δu_{d} is determined as 1 to 12 days, and the newly added unplanned maintenance days Δu_{d} for the in-service nuclear power plant 3 is optimized within 1 to 12 days.

In a second improvement, the planned holiday maintenance days m₃ of the in-service nuclear power plant 3 is adjusted to 11 days, and an adjustment interval of the newly added unplanned maintenance days Δu_{d} is determined as 1 to 12 days, and the newly added unplanned maintenance days Δu_{d} for the in-service nuclear power plant 3 is optimized within 1 to 12 days.

In a third improvement, the planned holiday maintenance days m₃ of the in-service nuclear power plant 3 is adjusted to 13 days, and an adjustment interval of the newly added unplanned maintenance days Δu_{d} is determined as 1 to 13 days, and the newly added unplanned maintenance days Δu_{d} for the in-service nuclear power plant 3 is optimized within 1 to 13 days.

In a fourth improvement, the planned holiday maintenance days m₃ of the in-service nuclear power plant 3 is adjusted to 14 days, and an adjustment interval of the newly added unplanned maintenance days AΔu_{d} is determined as 1 to 12 days, and the newly added unplanned maintenance days Δu_{d} for the in-service nuclear power plant 3 is optimized within 1 to 12 days.

In a fifth improvement, the planned holiday maintenance days m₃ of the in-service nuclear power plant 3 is adjusted to 15 days, and an adjustment interval of the newly added unplanned maintenance days Δu_{d} is determined as 1 to 12 days, and the newly added unplanned maintenance days Δu_{d} for the in-service nuclear power plant 3 is optimized within 1 to 12 days.

Manner 4: If the planned maintenance category is unplanned maintenance category, a lower limit of the second adjustment interval is greater than or equal to 1 day, and an upper limit of the second adjustment interval is less than or equal to 12 days.

The prediction values of the target equivalent availability factor E_{AF2}(sᵢ) corresponding to different newly added unplanned maintenance days Δu_{d} of the in-service nuclear power plant 3 are shown in Table 13.

TABLE 13
ΔE_{AF2}(sᵢ) of in-service nuclear power plant
3 corresponding to different Δu_{d}

| | newly added unplanned maintenance days Δu_{d} | | | | | |
|---|---|---|---|---|---|---|
| | 1 | 2 | 3 | 4 | 5 | 6 |
| equivalent | 0.9973 | 0.9945 | 0.9918 | 0.9890 | 0.9863 | 0.9836 |
| availability | | | | | | |
| factor E_{AF2}(sᵢ) | | | | | | |
| | newly added unplanned maintenance days Δu_{d} | | | | | |
| | 7 | 8 | 9 | 10 | 11 | 12 |
| equivalent | 0.9808 | 0.9781 | 0.9753 | 0.9726 | 0.9699 | 0.9671 |
| availability | | | | | | |
| factor E_{AF2}(sᵢ) | | | | | | |

As shown in Table 13, an adjustment interval of the newly added unplanned maintenance days Δu_{d} is determined as 1 to 12 days, and the newly added unplanned maintenance days Δu_{d} for the in-service nuclear power plant 3 within 1 to 12 days is optimized.

In summary, according to the method for high-precision increasing reliability for the in-service nuclear power plant in embodiments of the present disclosure, if the planned maintenance category only includes conventional island planned overhaul, the number of days for conventional island planned overhaul is optimized within the first adjustment interval. If the planned maintenance category only includes nuclear island refueling overhaul, the number of days for nuclear island refueling overhaul is optimized within the third adjustment interval. If the planned maintenance category only includes holiday planned overhaul, the planned maintenance days during holidays are optimized within the fourth adjustment interval. If the planned maintenance category only includes conventional island planned overhaul, or the planned maintenance category only includes nuclear island refueling overhaul, or the planned maintenance category only includes holiday planned maintenance, or the planned maintenance category is unplanned maintenance, the newly added unplanned maintenance days are optimized within the second adjustment interval, which is suitable for increasing reliability of the in-service nuclear power plants.

In order to achieve the above-mentioned embodiments, the present disclosure provided an apparatus for predicting and monitoring reliability for an in-service nuclear power plant.

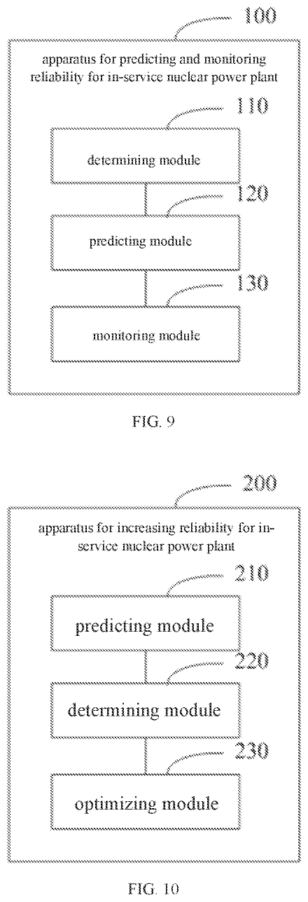

FIG. 9 is a schematic diagram showing an apparatus for predicting and monitoring reliability suitable for an in-service nuclear power plant according to an embodiment of the present disclosure.

As shown in FIG. 9, the apparatus 100 for predicting and monitoring reliability suitable for the in-service nuclear power plant in embodiments of the present disclosure includes a determining module 110, a predicting module 120 and a monitoring module 130.

The determining module 110 is configured to obtain a number of years of operation of the in-service nuclear power plant, and determine a target reliability prediction category of the in-service nuclear power plant based on the number of years of operation.

The predicting module 120 is configured to perform reliability prediction on the in-service nuclear power plant based on first reliability basic data of the in-service nuclear power plant in case that the target reliability prediction category is a first reliability prediction category.

The predicting module 120 is further configured to perform reliability prediction on the in-service nuclear power plant based on second reliability basic data of the in-service nuclear power plant in case that the target reliability prediction category is a second reliability prediction category.

The monitoring module 130 is configured to perform reliability monitoring on the in-service nuclear power plant based on a predicted reliability value and a planned maintenance category of the in-service nuclear power plant.

In an embodiment of the present disclosure, the determining module 110 is further configured to determine the target reliability prediction category as the first reliability prediction category in case that the number of years of operation is less than a first set threshold; or determine that the target reliability prediction category as the second reliability prediction category in case that the number of years of operation is greater than or equal to the first set threshold.

In an embodiment of the present disclosure, the predicting module 120 is further configured to determine an acquisition strategy of reliability basic data for predicting the reliability of the in-service nuclear power plant based on the target reliability prediction category, in which the acquisition strategy includes a source in-service nuclear power plant and a data collection condition of the reliability basic data; perform data collection on the source in-service nuclear power plant based on the data collection condition to obtain the reliability basic data for predicting the reliability of the in-service nuclear power plant.

In an embodiment of the present disclosure, the predicting module 120 is further configured to determine, as the source in-service nuclear power plant, a reference in-service nuclear power plant with the same power as the in-service nuclear power plant in case that the target reliability prediction category is the first reliability prediction category; and determine, as the first reliability basic data of the in-service nuclear power plant, reliability basic data of the source in-service nuclear power plant in a plurality of historical years of operation.

In an embodiment of the present disclosure, the predicting module 120 is further configured to determine the in-service nuclear power plant as the source in-service nuclear power plant in case that the target reliability prediction category is the second reliability prediction category; and determine, as the second reliability basic data of the in-service nuclear power plant, reliability basic data of the in-service nuclear power plant in a plurality of historical years of operation.

In an embodiment of the present disclosure, the predicting module 120 is further configured to determine a first planned outage-deducting equivalent availability factor based on a first equivalent availability factor and a first planned outage factor in the first reliability basic data; and obtain the reliability prediction value of the in-service nuclear power plant in different planned maintenance categories based on the first planned outage-deducting equivalent availability factor.

In an embodiment of the present disclosure, the predicting module 120 is further configured to determine the first planned outage-deducting equivalent availability factor based on an average value of the first equivalent availability factors of the source in-service nuclear power plant in the plurality of historical years of operation, and an average value of the first planned outage factors of the source in-service nuclear power plant in the plurality of historical years of operation.

In an embodiment of the present disclosure, the predicting module 120 is further configured to obtain the reliability prediction value of the in-service nuclear power plant in the year of conventional island planned overhaul based on the equivalent availability factor of the first outage-deducting equivalent availability factor, conventional island planned overhaul days for the in-service nuclear power plant, and newly added unplanned overhaul days in case that the planned maintenance category only includes conventional island planned overhaul.

In an embodiment of the present disclosure, the predicting module 120 is further configured to obtain the reliability prediction value of the in-service nuclear power plant in the year of nuclear island refueling overhaul based on the first outage-deducting equivalent availability factor, nuclear island refueling overhaul days for the in-service nuclear power plant, and newly added unplanned maintenance days in case that the planned maintenance category only includes nuclear island refueling overhaul.

In an embodiment of the present disclosure, the predicting module 120 is further configured to obtain the reliability prediction value of the in-service nuclear power plant in the holiday planned maintenance year based on the first outage-deducting equivalent availability factor, the holiday planned maintenance days of the in-service nuclear power plant, and the newly added unplanned maintenance days in case that the planned maintenance category only includes holiday planned maintenance.

In an embodiment of the present disclosure, the predicting module 120 is further configured to obtain the reliability prediction value of the in-service nuclear power plant in an unplanned maintenance year based on the first outage-deducting equivalent availability factor and newly added unplanned maintenance days of the in-service nuclear power plant in case that the planned maintenance category is an unplanned maintenance category.

In an embodiment of the present disclosure, the predicting module 120 is further configured to obtain the reliability prediction value of the source in-service nuclear power plant in an i^{th} historical year of operation by predicting a reliability characteristic quantity of the source in-service nuclear power plant in the i^{th} historical year of operation based on a first planned outage factor and a first planned outage-deducting equivalent availability factor of the source in-service nuclear power plant from the i^{th} historical year of operation; and perform prediction accuracy verification on the reliability prediction value of the in-service nuclear power plant based on a relative error between the reliability prediction value and a reliability characteristic quantity statistical value of the source in-service nuclear power plant in the same historical year of operation.

In an embodiment of the present disclosure, the predicting module 120 is further configured to determine a planned outage-deducting maintenance factor of the in-service nuclear power plant in a current year of operation based on a second equivalent availability factor and a second planned outage factor in the second reliability basic data; and obtain a reliability prediction value of the in-service nuclear power plant in different planned maintenance categories based on the planned outage-deducting maintenance factor of the in-service nuclear power plant in the current year of operation.

In an embodiment of the present disclosure, the predicting module 120 is further configured to obtain planned outage-deducting maintenance factors of the in-service nuclear power plant in the plurality of historical years of operation based on the second equivalent availability factor and the second planned outage factor in the second reliability basic data; obtain a power function expression of the planned outage-deducting maintenance factor of the in-service nuclear power plant based on the planned outage-deducting maintenance factor of the in-service nuclear power plant in the plurality of historical years of operation; and obtain the planned outage-deducting maintenance factor of the in-service nuclear power plant in the current year of operation based on the power function expression.

In an embodiment of the present disclosure, the predicting module 120 is further configured to obtain a second planned outage-deducting equivalent availability factor of the in-service nuclear power plant in the i^{th} historical year of operation based on the second equivalent availability factor and the second planned outage factor of the in-service nuclear power plant in the i^{th} historical year of operation, where i is a positive integer; and obtain the planned outage-deducting maintenance factor of the in-service nuclear power plant in the i^{th} historical year of operation based on the second planned outage-deducting equivalent availability factor of the in-service nuclear power plant in the i^{th} historical year of operation.

In an embodiment of the present disclosure, the predicting module 120 is further configured to obtain the reliability prediction value of the in-service nuclear power plant in the conventional island planned overhaul year based on the planned outage-deducting maintenance factor, conventional island planned overhaul days, and newly added unplanned maintenance days for the in-service nuclear power plant in the current year of operation in case that the planned maintenance category only includes conventional island planned overhaul.

In an embodiment of the present disclosure, the predicting module 120 is further configured to obtain the reliability prediction value of the in-service nuclear power plant in the nuclear island refueling overhaul year based on the planned outage-deducting maintenance factor, nuclear island refueling overhaul days, and newly added unplanned maintenance days for the in-service nuclear power plant in the current year of operation in case that the planned maintenance category only includes nuclear island refueling overhaul.

In an embodiment of the present disclosure, the predicting module 120 is further configured to obtain the reliability prediction value of the in-service nuclear power plant in the holiday planned maintenance year based on the planned outage-deducting maintenance factor, holiday planned maintenance days, and newly added unplanned maintenance days for the in-service nuclear power plant in the current year of operation in case that the planned maintenance category only includes holiday planned maintenance.

In an embodiment of the present disclosure, the predicting module 120 is further configured to obtain the reliability prediction value of the in-service nuclear power plant in the unplanned maintenance year based on the planned outage-deducting maintenance factor and the newly added unplanned maintenance days for the in-service nuclear power plant in the current year of operation in case that the planned maintenance category is an unplanned maintenance category,

In an embodiment of the present disclosure, the predicting module 120 is further configured to obtain a second planned outage-deducting equivalent availability factor of the in-service nuclear power plant in the i^{th} historical year of operation based on the second equivalent availability factor and the second planned outage factor of the in-service nuclear power plant in the i^{th} historical year of operation, where i is a positive integer; obtain the reliability prediction value of the in-service nuclear power plant in the i^{th} historical year of operation based on the second planned outage-deducting equivalent availability factor and the second planned outage factor of the in-service nuclear power plant in the i^{th} historical year of operation; and perform prediction accuracy verification on the reliability prediction value of the in-service nuclear power plant based on a relative error between the reliability prediction value and a reliability characteristic quantity statistical value of the in-service nuclear power plant in the same historical year of operation.

In an embodiment of the present disclosure, the monitoring module 130 is further configured to determine a monitoring qualification condition for the in-service nuclear power plant based on the planned maintenance category; and determine whether the reliability prediction value meets the monitoring qualification condition to perform reliability monitoring on the in-service nuclear power plant.

In an embodiment of the present disclosure, the monitoring module 130 is further configured to determine a reliability monitoring criterion value of the in-service nuclear power plant based on the planned maintenance category; and determine the monitoring qualification condition based on the reliability monitoring criterion value.

In an embodiment of the present disclosure, the monitoring module 130 is further configured to obtain the first reliability monitoring criterion value of the in service nuclear power plant if the planned maintenance category only includes conventional island planned overhaul; or obtain the second reliability monitoring criterion value for the in-service nuclear power plant if the planned maintenance category only includes nuclear island refueling overhaul; or obtain the third reliability monitoring criterion value of the in-service nuclear power plant if the planned maintenance category only includes holiday planned maintenance; or obtain the fourth reliability monitoring criterion value for the in-service nuclear power plant if the planned maintenance category is unplanned maintenance category.

In an embodiment of the present disclosure, the monitoring module 130 is further configured to determine that the reliability prediction value is greater than or equal to the reliability monitoring criterion value as the monitoring qualification condition.

It is noted that the details not disclosed in the apparatus for predicting and monitoring reliability for the in-service nuclear power plant in embodiments are referred to in the method for predicting and monitoring reliability for the in-service nuclear power plant in embodiments the present disclosure, which will not be further elaborated here.

In summary, in the apparatus for high-precision predicting and monitoring reliability suitable for an in-service nuclear power plant in embodiments of the present disclosure, the number of years of operation of the in-service nuclear power plant is obtained, and a target reliability prediction category of the in-service nuclear power plant is determined based on the number of years of operation. In case that the target reliability prediction category is a first reliability prediction category, reliability prediction is performed on the in-service nuclear power plant based on first reliability basic data of the in-service nuclear power plant. In case that the target reliability prediction category is a second reliability prediction category, reliability prediction is performed on the in-service nuclear power plant based on second reliability basic data of the in-service nuclear power plant. Reliability monitoring is performed on the in-service nuclear power plant based on a reliability prediction value and a planned maintenance category of the in-service nuclear power plant. In this way, the target reliability prediction category may be determined based on the number of years of operation of in-service nuclear power plants, so as to predict the reliability of the in-service nuclear power plant, thereby improving the prediction accuracy of reliability of the in-service nuclear power plant. The reliability prediction value and the planned maintenance category of the in-service nuclear power plant are comprehensively considered to monitor the reliability of the in-service nuclear power plant, thereby improving the monitoring accuracy of reliability of the in-service nuclear power plant.

In order to achieve the above-mentioned embodiments, the present disclosure provides an apparatus for increasing reliability for an in-service nuclear power plant.

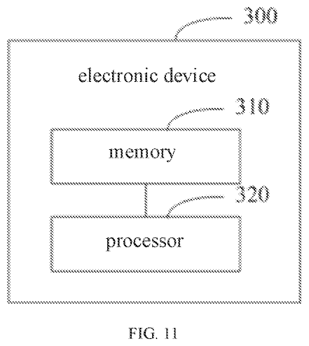

FIG. 10 is a schematic diagram showing an apparatus for increasing reliability suitable for an in-service nuclear power plant according to an embodiment of the present disclosure.

As shown in FIG. 10, the apparatus 200 increasing reliability suitable for an in-service nuclear power plant in embodiments of the present disclosure includes a predicting module 210, a determining module 220, and an optimizing module 230.

The predicting module 210 is configured to perform reliability prediction on the in-service nuclear power plant based on a number of years of operation of the in-service nuclear power plant to obtain a reliability prediction value of the in-service nuclear power plant.

The determining module 220 is configured to determine abnormal reliability data of the in-service nuclear power plant based on a planned maintenance category of the in-service nuclear power plant in case that the reliability prediction value does not meet a monitoring qualification condition.

The optimizing module 230 is configured to optimize the abnormal reliability data, and return to perform a process of obtaining the reliability prediction value until the reliability prediction value obtained meets the monitoring qualification condition.

In an embodiment of the present disclosure, the abnormal reliability data includes planned maintenance days corresponding to the planned maintenance category and/or newly added unplanned maintenance days of the in-service nuclear power plant.

The optimization module 230 is further configured to determine an adjustment interval of the planned maintenance days based on the planned maintenance category, and optimize the planned maintenance days within the adjustment interval of the planned maintenance days; and determine an adjustment interval of the newly added unplanned maintenance days, and optimizing the newly added unplanned maintenance days within the adjustment interval of the newly added unplanned maintenance days.

In an embodiment of the present disclosure, if the planned maintenance category only includes conventional island planned overhaul, the optimizing module 230 is further configured to determine a first adjustment interval as an adjustment interval for the planned conventional island overhaul days of, and optimize the planned conventional island overhaul days within the first adjustment interval; determine a second adjustment interval as the adjustment interval for the newly added unplanned maintenance days, and optimize the newly added unplanned maintenance days within the second adjustment interval.

In an embodiment of the present disclosure, if the planned maintenance category only includes nuclear island refueling overhaul, the optimizing module 230 is further configured to determine a third adjustment interval as the adjustment interval for nuclear island refueling overhaul days, and optimize nuclear island refueling overhaul days within the third adjustment interval; determine a second adjustment interval as the adjustment interval for the newly added unplanned maintenance days, and optimize the newly added unplanned maintenance days within the second adjustment interval.

In an embodiment of the present disclosure, if the planned maintenance category only includes holiday planned maintenance, the optimizing module 230 is further configured to determine a fourth adjustment interval as an adjustment interval for holiday planned maintenance days, and optimize the holiday planned maintenance days within the fourth adjustment interval; determine a second adjustment interval as the adjustment interval for the newly added unplanned maintenance days, and optimize the newly added unplanned maintenance days within the second adjustment interval.

In an embodiment of the present disclosure, if the planned maintenance category is an unplanned maintenance category, the optimizing module 230 is further configured to determine a second adjustment interval as the adjustment interval for the newly added unplanned maintenance days, and optimize the newly added unplanned maintenance days within the second adjustment interval.

In an embodiment of the present disclosure, the predicting module 210 is further configured to obtain the number of years of operation of the in-service nuclear power plant and determine the target reliability prediction category of the in-service nuclear power plant based on the number of years of operation; perform reliability prediction on the in-service nuclear power plant based on the first reliability basic data of the in-service nuclear power plan if the target reliability prediction category is the first reliability prediction category; perform reliability prediction on the in-service nuclear power plant based on the second reliability basic data of the in-service nuclear power plant if the target reliability prediction category is the second reliability prediction category.

In an embodiment of the present disclosure, the predicting module 210 is further configured to determine that the target reliability prediction category is the first reliability prediction category in case that the number of years in operation is less than the first set threshold; or determine that the target reliability prediction category is the second reliability prediction category in case that the number of years of operation is greater than or equal to the first set threshold.

In an embodiment of the present disclosure, the predicting module 210 is further configured to determine an acquisition strategy of reliability basic data for predicting the reliability of the in-service nuclear power plant based on the target reliability prediction category, in which the acquisition strategy comprises a source in-service nuclear power plant and a data collection condition of the reliability basic data; perform data collection on the source in-service nuclear power plant based on the data collection condition to obtain the reliability basic data for predicting the reliability of the in-service nuclear power plant.

In an embodiment of the present disclosure, the predicting module 210 is further configured to determine, as the source in-service nuclear power plant, a reference in-service nuclear power plant with the same power as the in-service nuclear power plant in case that the target reliability prediction category is the first reliability prediction category; and determine, as the first reliability basic data of the in-service nuclear power plant, reliability basic data of the source in-service nuclear power plant in a plurality of historical years of operation.

In an embodiment of the present disclosure, the predicting module 210 is further configured to determine the in-service nuclear power plant as the source in-service nuclear power plant in case that the target reliability prediction category is the second reliability prediction category; and determine, as the second reliability basic data of the in-service nuclear power plant, reliability basic data of the in-service nuclear power plant in a plurality of historical years of operation.

In an embodiment of the present disclosure, the determining module 220 is further configured to determine a monitoring qualification condition of the in-service nuclear power plant group based on the planned maintenance category.

In an embodiment of the present disclosure, the determining module 220 is further configured to determine a reliability monitoring criterion value of the in-service nuclear power plant based on the planned maintenance category; and determine the monitoring qualification condition based on the reliability monitoring criterion value.

In an embodiment of the present disclosure, the determining module 220 is further configured to determine that the reliability prediction value is greater than or equal to the reliability monitoring criterion value as the monitoring qualification condition.

It is noted that the details not disclosed in the apparatus for increasing reliability for the in-service nuclear power plant in embodiments are referred to in the method for increasing reliability for the in-service nuclear power plant in embodiments the present disclosure, which will not be further elaborated here.

In summary, according to the apparatus for high-precision increasing reliability for the in-service nuclear power plant in embodiments of the present disclosure, if the reliability prediction value does not meet the monitoring qualification conditions, the abnormal reliability data of the in-service nuclear power plant is determined based on the planned maintenance category, the abnormal reliability data is optimized, and the process of obtaining the reliability prediction value is returned to perform until the obtained reliability prediction value meets the monitoring qualification conditions. Therefore, when the reliability prediction value does not meet the monitoring qualification conditions, the abnormal reliability data may be optimized, and the process of obtaining the reliability prediction value may be returned to execute until the obtained reliability prediction value meets the monitoring qualification conditions, which may improve the reliability of the in-service nuclear power plant.

In order to implement the above-mentioned embodiment, as shown in FIG. 11, the present disclosure provides an electronic device 300, which includes a memory 310, a processor 320, and computer programs stored in the memory 310 and executable by the processor 320. When the processor 320 is configured to execute the computer programs, the method for predicting and monitoring reliability for an in-service nuclear power plant and/or the method for high-precision increasing reliability for an in-service nuclear power plant mentioned above may be implemented.

In the electronic device in embodiments of the present disclosure, the computer program stored in the memory is executed through the processor to obtain the number of years of operation of the in-service nuclear power plant, and determine a target reliability prediction category of the in-service nuclear power plant based on the number of years of operation; perform reliability prediction on the in-service nuclear power plant based on first reliability basic data of the in-service nuclear power plant in case that the target reliability prediction category is a first reliability prediction category; perform reliability prediction on the in-service nuclear power plant based on second reliability basic data of the in-service nuclear power plant in case that the target reliability prediction category is a second reliability prediction category; perform reliability monitoring on the in-service nuclear power plant based on a reliability prediction value and a planned maintenance category of the in-service nuclear power plant. In this way, the target reliability prediction category may be determined based on the number of years of operation of in-service nuclear power plants, so as to predict the reliability of the in-service nuclear power plant, thereby improving the prediction accuracy of reliability of the in-service nuclear power plant. The reliability prediction value and the planned maintenance category of the in-service nuclear power plant are comprehensively considered to monitor the reliability of the in-service nuclear power plant, thereby improving the monitoring accuracy of reliability of the in-service nuclear power plant.

In order to implement the above-mentioned embodiments, the present disclosure provides a computer-readable storage medium on which a computer program is stored. When the program is executed by a processor, the steps of the method for predicting and monitoring reliability for an in-service nuclear power plant and/or the method for increasing reliability for an in-service nuclear power plant mentioned above may be implemented.

In the computer-readable storage medium in embodiments of the present disclosure, the computer program stored in the memory is executed through the processor to obtain the number of years of operation of the in-service nuclear power plant, and determine a target reliability prediction category of the in-service nuclear power plant based on the number of years of operation; perform reliability prediction on the in-service nuclear power plant based on first reliability basic data of the in-service nuclear power plant in case that the target reliability prediction category is a first reliability prediction category; perform reliability prediction on the in-service nuclear power plant based on second reliability basic data of the in-service nuclear power plant in case that the target reliability prediction category is a second reliability prediction category; perform reliability monitoring on the in-service nuclear power plant based on a reliability prediction value and a planned maintenance category of the in-service nuclear power plant. In this way, the target reliability prediction category may be determined based on the number of years of operation of in-service nuclear power plants, so as to predict the reliability of the in-service nuclear power plant, thereby improving the prediction accuracy of reliability of the in-service nuclear power plant. The reliability prediction value and the planned maintenance category of the in-service nuclear power plant are comprehensively considered to monitor the reliability of the in-service nuclear power plant, thereby improving the monitoring accuracy of reliability of the in-service nuclear power plant.

In order to implement the above-mentioned embodiments, the present disclosure provides a platform for monitoring reliability for an in-service nuclear power plant, which includes the apparatus for predicting and monitoring reliability for the in-service nuclear power plant as shown in FIG. 9, and/or the apparatus for increasing reliability for an in-service nuclear power plant as shown in FIG. 10; or the above-mentioned electronic device; or the above-mentioned computer-readable storage medium.

In the platform for monitoring reliability for the in-service nuclear power plant in embodiments of the present disclosure, the number of years of operation of the in-service nuclear power plant is obtained, and a target reliability prediction category of the in-service nuclear power plant is determined based on the number of years of operation. In case that the target reliability prediction category is a first reliability prediction category, reliability prediction is performed on the in-service nuclear power plant based on first reliability basic data of the in-service nuclear power plant. In case that the target reliability prediction category is a second reliability prediction category, reliability prediction is performed on the in-service nuclear power plant based on second reliability basic data of the in-service nuclear power plant. Reliability monitoring is performed on the in-service nuclear power plant based on a reliability prediction value and a planned maintenance category of the in-service nuclear power plant. In this way, the target reliability prediction category may be determined based on the number of years of operation of in-service nuclear power plants, so as to predict the reliability of the in-service nuclear power plant, thereby improving the prediction accuracy of reliability of the in-service nuclear power plant. The reliability prediction value and the planned maintenance category of the in-service nuclear power plant are comprehensively considered to monitor the reliability of the in-service nuclear power plant, thereby improving the monitoring accuracy of reliability of the in-service nuclear power plant. The planned and unplanned maintenance days of the in-service nuclear power plant may also be optimized and improved, so as to increasing reliability of the in-service nuclear power plant.

In the specification, it is to be understood that terms such as “central,” “longitudinal,” “lateral,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise”, “axial”, “radial” and “circumferential” should be construed to refer to the orientation or positional relationship as then described or as shown in the drawings under discussion, which are only for the convenience of describing and simplifying the present disclosure, rather than indicating or implying that the device or component referred to must have a specific orientation, be constructed and operated in a specific orientation, and therefore cannot be understood as a limitation of the present disclosure.

In addition, terms such as “first” and “second” are used herein for purposes of description and are not intended to indicate or imply relative importance or significance or to imply the number of indicated technical features. Thus, the feature defined with “first” and “second” may comprise one or more of this feature. In the description of the present invention, “a plurality of” means two or more than two, unless specified otherwise.

In the present invention, unless specified or limited otherwise, the terms “mounted,” “connected,” “coupled,” “fixed” and the like are used broadly, and may be, for example, fixed connections, detachable connections, or integral connections; may also be mechanical or electrical connections; may also be direct connections or indirect connections via intervening structures; may also be inner communications of two elements, which can be understood by those skilled in the art according to specific situations.

In the present invention, unless specified or limited otherwise, a structure in which a first feature is “on” or “below” a second feature may include an embodiment in which the first feature is in direct contact with the second feature, and may also include an embodiment in which the first feature and the second feature are not in direct contact with each other, but are contacted via an additional feature formed therebetween. Furthermore, a first feature “on,” “above,” or “on top of” a second feature may include an embodiment in which the first feature is right or obliquely “on,” “above,” or “on top of” the second feature, or just means that the first feature is at a height higher than that of the second feature; while a first feature “below,” “under,” or “on bottom of” a second feature may include an embodiment in which the first feature is right or obliquely “below,” “under,” or “on bottom of” the second feature, or just means that the first feature is at a height lower than that of the second feature.

In the description of the specification, descriptions referring to the terms “an embodiment”, “some embodiments”, “an example”, “a specific example”, or “some examples” mean that specific features, structures, materials or characteristics described in connection with embodiments or examples are included in at least some embodiments or example of the present disclosure. In this specification, schematic representations of the above terms do not necessarily refer to the same embodiment or example. Furthermore, the specific features, structures, materials or characteristics described may be combined in any suitable manner in any one or more embodiments or examples. In addition, those skilled in the art may combine the different embodiments or examples described in this specification, as well as the features of different embodiments or examples, without mutual contradiction.

Although the embodiments of the present application have been shown and described above, it is understood that the above-mentioned embodiments are illustrative and should not be construed as limitations on the present disclosure, and those skilled in the art may make the above-mentioned embodiments are subject to changes, modifications, substitutions and variations.

1. A method for high-precisely predicting and monitoring reliability, suitable for an in-service nuclear power plant and comprising:
obtaining a number of years of operation of the in-service nuclear power plant, and determining a target reliability prediction category of the in-service nuclear power plant based on the number of years of operation;
performing reliability prediction on the in-service nuclear power plant based on first reliability basic data of the in-service nuclear power plant in case that the target reliability prediction category is a first reliability prediction category;
performing reliability prediction on the in-service nuclear power plant based on second reliability basic data of the in-service nuclear power plant in case that the target reliability prediction category is a second reliability prediction category;
performing reliability monitoring on the in-service nuclear power plant based on a reliability prediction value and a planned maintenance category of the in-service nuclear power plant;
determining the in-service nuclear power plant as a source in-service nuclear power plant of the second reliability basic data in case that the target reliability prediction category is the second reliability prediction category;
determining, as the second reliability basic data of the in-service nuclear power plant, reliability basic data of the in-service nuclear power plant in a plurality of historical years of operation;
determining a planned outage-deducting maintenance factor of the in-service nuclear power plant in a current year of operation based on a second equivalent availability factor and a second planned outage factor in the second reliability basic data;
obtaining a reliability prediction value of the in-service nuclear power plant in different planned maintenance categories based on the planned outage-deducting maintenance factor of the in-service nuclear power plant in the current year of operation;
wherein determining the planned outage-deducting maintenance factor of the in-service nuclear power plant in the current year of operation based on the second equivalent availability factor and the second planned outage factor in the second reliability basic data comprises:
obtaining planned outage-deducting maintenance factors of the in-service nuclear power plant in the plurality of historical years of operation based on the second equivalent availability factor and the second planned outage factor in the second reliability basic data;
obtaining a power function expression of the planned outage-deducting maintenance factor of the in-service nuclear power plant based on the planned outage-deducting maintenance factor of the in-service nuclear power plant in the plurality of historical years of operation;
obtaining the planned outage-deducting maintenance factor of the in-service nuclear power plant in the current year of operation based on the power function expression.

2. The method according to claim 1, wherein determining the target reliability prediction category of the in-service nuclear power plant based on the number of years of operation comprises:
determining the target reliability prediction category as the first reliability prediction category in case that the number of years of operation is less than a first set threshold; or
determining that the target reliability prediction category as the second reliability prediction category in case that the number of years of operation is greater than or equal to the first set threshold.

3. The method according to claim 1, further comprising:
determining an acquisition strategy of reliability basic data for predicting the reliability of the in-service nuclear power plant based on the target reliability prediction category, wherein the acquisition strategy comprises a source in-service nuclear power plant and a data collection condition of the reliability basic data;
performing data collection on the source in-service nuclear power plant based on the data collection condition to obtain the reliability basic data for predicting the reliability of the in-service nuclear power plant.

4. The method according to claim 3, further comprising:
determining, as the source in-service nuclear power plant, a reference in-service nuclear power plant with the same power as the in-service nuclear power plant in case that the target reliability prediction category is the first reliability prediction category,
determining, as the first reliability basic data of the in-service nuclear power plant, reliability basic data of the source in-service nuclear power plant in the plurality of historical years of operation.

5. (canceled)

6. The method according to claim 4, wherein performing reliability prediction on the in-service nuclear power plant based on the first reliability basic data of the in-service nuclear power plant comprises:
determining a first planned outage-deducting equivalent availability factor based on a first equivalent availability factor and a first planned outage factor in the first reliability basic data;
obtaining the reliability prediction value of the in-service nuclear power plant in different planned maintenance categories based on the first planned outage-deducting equivalent availability factor.

7. The method according to claim 6, wherein determining the first planned outage-deducting equivalent availability factor based on the first equivalent availability factor and the first planned outage factor in the first reliability basic data comprises:
determining the first planned outage-deducting equivalent availability factor based on an average value of the first equivalent availability factors of the source in-service nuclear power plant in the plurality of historical years of operation, and an average value of the first planned outage factors of the source in-service nuclear power plant in the plurality of historical years of operation.

8. The method according to claim 6, further comprising:
obtaining the reliability prediction value of the source in-service nuclear power plant in an i^{th} historical year of operation by predicting a reliability characteristic quantity of the source in-service nuclear power plant in the i^{th} historical year of operation based on a first planned outage factor and a first planned outage-deducting equivalent availability factor of the source in-service nuclear power plant in the i^{th} historical year of operation; and
performing prediction accuracy verification on the reliability prediction value of the in-service nuclear power plant based on a relative error between the reliability prediction value and a reliability characteristic quantity statistical value of the source in-service nuclear power plant in the same historical year of operation.

9. (canceled)

10. (canceled)

11. The method according to claim 1, wherein obtaining the planned outage-deducting maintenance factors of the in-service nuclear power plant in the plurality of historical years of operation based on the second equivalent availability factor and the second planned outage factor in the second reliability basic data comprises:
obtaining a second planned outage-deducting equivalent availability factor of the in-service nuclear power plant in the i^{th} historical year of operation based on the second equivalent availability factor and the second planned outage factor of the in-service nuclear power plant in the i^{th} historical year of operation, where i is a positive integer;
obtaining the planned outage-deducting maintenance factor of the in-service nuclear power plant in the i^{th} historical year of operation based on the second planned outage-deducting equivalent availability factor of the in-service nuclear power plant in the i^{th} historical year of operation.

12. The method according to claim 1, further comprising:
obtaining a second planned outage-deducting equivalent availability factor of the in-service nuclear power plant in the i^{th} historical year of operation based on the second equivalent availability factor and the second planned outage factor of the in-service nuclear power plant in the i^{th} historical year of operation, where i is a positive integer;
obtaining the reliability prediction value of the in-service nuclear power plant in the i^{th} historical year of operation based on the second planned outage-deducting equivalent availability factor and the second planned outage factor of the in-service nuclear power plant in the i^{th} historical year of operation;
performing prediction accuracy verification on the reliability prediction value of the in-service nuclear power plant based on a relative error between the reliability prediction value and a reliability characteristic quantity statistical value of the in-service nuclear power plant in the same historical year of operation.

13. The method according to claim 1, wherein performing reliability monitoring on the in-service nuclear power plant based on the reliability prediction value and the planned maintenance category of the in-service nuclear power plant comprises:
determining a monitoring qualification condition for the in-service nuclear power plant based on the planned maintenance category;
determining whether the reliability prediction value meets the monitoring qualification condition to perform reliability monitoring on the in-service nuclear power plant.

14. The method according to claim 13, wherein determining the monitoring qualification condition for the in-service nuclear power plant based on the planned maintenance category comprises:
determining a reliability monitoring criterion value of the in-service nuclear power plant based on the planned maintenance category;
determining the monitoring qualification condition based on the reliability monitoring criterion value.

15. The method according to claim 14, wherein determining the monitoring qualification condition based on the reliability monitoring criterion value comprises:
determining that the reliability prediction value is greater than or equal to the reliability monitoring criterion value as the monitoring qualification condition.

16. A method for increasing reliability, suitable for an in-service nuclear power plant and comprising:
performing reliability prediction on the in-service nuclear power plant based on a number of years of operation of the in-service nuclear power plant to obtain a reliability prediction value of the in-service nuclear power plant;
determining reliability data of the in-service nuclear power plant based on a planned maintenance category of the in-service nuclear power plant in case that the reliability prediction value does not meet a monitoring qualification condition;
optimizing the reliability data, and returning to perform a process of obtaining the reliability prediction value until the reliability prediction value obtained meets the monitoring qualification condition;
wherein the reliability abnormal data comprises planned maintenance days corresponding to the planned maintenance category and newly added unplanned maintenance days of the in-service nuclear power plant;
optimizing the reliability abnormal data comprises:
determining an adjustment interval of the planned maintenance days based on the planned maintenance category, and optimizing the planned maintenance days within the adjustment interval of the planned maintenance days;
determining an adjustment interval of the newly added unplanned maintenance days, and optimizing the newly added unplanned maintenance days within the adjustment interval of the newly added unplanned maintenance days.

17.-20. (canceled)

21. An electronic device, comprising:
a processor; and
a memory for storing computer programs executable by the processor;
wherein the processor is configured to execute the computer programs to:
obtain a number of years of operation of an in-service nuclear power plant, and determine a target reliability prediction category of the in-service nuclear power plant based on the number of years of operation;
perform reliability prediction on the in-service nuclear power plant based on first reliability basic data of the in-service nuclear power plant in case that the target reliability prediction category is a first reliability prediction category;
perform reliability prediction on the in-service nuclear power plant based on second reliability basic data of the in-service nuclear power plant in case that the target reliability prediction category is a second reliability prediction category;
perform reliability monitoring on the in-service nuclear power plant based on a reliability prediction value and a planned maintenance category of the in-service nuclear power plant;
determine the in-service nuclear power plant as a source in-service nuclear power plant of the second reliability basic data in case that the target reliability prediction category is the second reliability prediction category;
determine, as the second reliability basic data of the in-service nuclear power plant, reliability basic data of the in-service nuclear power plant in a plurality of historical years of operation;
determine a planned outage-deducting maintenance factor of the in-service nuclear power plant in a current year of operation based on a second equivalent availability factor and a second planned outage factor in the second reliability basic data;
obtain a reliability prediction value of the in-service nuclear power plant in different planned maintenance categories based on the planned outage-deducting maintenance factor of the in-service nuclear power plant in the current year of operation;
wherein determining the planned outage-deducting maintenance factor of the in-service nuclear power plant in the current year of operation based on the second equivalent availability factor and the second planned outage factor in the second reliability basic data comprises:
obtaining planned outage-deducting maintenance factors of the in-service nuclear power plant in the plurality of historical years of operation based on the second equivalent availability factor and the second planned outage factor in the second reliability basic data;
obtaining a power function expression of the planned outage-deducting maintenance factor of the in-service nuclear power plant based on the planned outage-deducting maintenance factor of the in-service nuclear power plant in the plurality of historical years of operation;
obtaining the planned outage-deducting maintenance factor of the in-service nuclear power plant in the current year of operation based on the power function expression.

22. The electronic device according to claim 21, wherein determining the target reliability prediction category of the in-service nuclear power plant based on the number of years of operation comprises:
determining the target reliability prediction category as the first reliability prediction category in case that the number of years of operation is less than a first set threshold; or
determining that the target reliability prediction category as the second reliability prediction category in case that the number of years of operation is greater than or equal to the first set threshold.

23. The electronic device according to claim 21, wherein the processor is further configured to:
determine an acquisition strategy of reliability basic data for predicting the reliability of the in-service nuclear power plant based on the target reliability prediction category, wherein the acquisition strategy comprises a source in-service nuclear power plant and a data collection condition of the reliability basic data;
perform data collection on the source in-service nuclear power plant based on the data collection condition to obtain the reliability basic data for predicting the reliability of the in-service nuclear power plant.

24. The electronic device according to claim 23, wherein the processor is further configured to:
determine, as the source in-service nuclear power plant, a reference in-service nuclear power plant with the same power as the in-service nuclear power plant in case that the target reliability prediction category is the first reliability prediction category,
determine, as the first reliability basic data of the in-service nuclear power plant, reliability basic data of the source in-service nuclear power plant in the plurality of historical years of operation.

25. The electronic device according to claim 24, wherein performing reliability prediction on the in-service nuclear power plant based on the first reliability basic data of the in-service nuclear power plant comprises:
determining a first planned outage-deducting equivalent availability factor based on a first equivalent availability factor and a first planned outage factor in the first reliability basic data;
obtaining the reliability prediction value of the in-service nuclear power plant in different planned maintenance categories based on the first planned outage-deducting equivalent availability factor.

26. The electronic device according to claim 25, wherein determining the first planned outage-deducting equivalent availability factor based on the first equivalent availability factor and the first planned outage factor in the first reliability basic data comprises:
determining the first planned outage-deducting equivalent availability factor based on an average value of the first equivalent availability factors of the source in-service nuclear power plant in the plurality of historical years of operation, and an average value of the first planned outage factors of the source in-service nuclear power plant in the plurality of historical years of operation.

27. The electronic device according to claim 25, wherein the processor is further configured to:
obtain the reliability prediction value of the source in-service nuclear power plant in an i^{th} historical year of operation by predicting a reliability characteristic quantity of the source in-service nuclear power plant in the i^{th} historical year of operation based on a first planned outage factor and a first planned outage-deducting equivalent availability factor of the source in-service nuclear power plant in the i^{th} historical year of operation; and
perform prediction accuracy verification on the reliability prediction value of the in-service nuclear power plant based on a relative error between the reliability prediction value and a reliability characteristic quantity statistical value of the source in-service nuclear power plant in the same historical year of operation.
